(19) United States
(12) Patent Application Publication
(10) Pub. No.: US 2025/0093888 A1
(43) Pub. Date: Mar. 20, 2025

(54) CONTROL DEVICE AND CONTROL METHOD

(71) Applicant: TOYOTA JIDOSHA KABUSHIKI KAISHA, Toyota-shi (JP)

(72) Inventors: Shogo YASUYAMA, Okazaki-shi (JP); Kento Iwahori, Nagoya-shi (JP); Daiki Yokoyama, Miyoshi-shi (JP)

(73) Assignee: TOYOTA JIDOSHA KABUSHIKI KAISHA, Toyota-shi (JP)

(21) Appl. No.: 18/758,262

(22) Filed: Jun. 28, 2024

(30) Foreign Application Priority Data
Sep. 15, 2023 (JP) 2023-150112
Dec. 1, 2023 (JP) 2023-203826

(51) Int. Cl. G05D 1/87

(52) U.S. Cl. CPC G05D 1/87

(57) ABSTRACT

A control device for controlling an action of a movable body that can be moved by unmanned driving includes an acquisition unit that acquires disturbance information regarding an external factor that affects control of the unmanned driving and is different from the external factor of the mobile body, and a control unit that changes a control form of the action of the mobile body using the disturbance information.

### CROSS-REFERENCE TO RELATED APPLICATION

This application claims priority to Japanese Patent Application No. 2023-150112 filed on Sep. 15, 2023 and Japanese Patent Application No. 2023-203826 filed on Dec. 1, 2023, each incorporated herein by reference in its entirety.

### BACKGROUND

### 1. Technical Field

The present disclosure relates to a control device and a control method.

### 2. Description of Related Art

Conventionally, there is known a management system that manages a state of an unmanned driving vehicle by an unmanned driving support center periodically communicating with the unmanned driving vehicle that performs automated driving (Japanese Unexamined Patent Application Publication No. 2021-71753 (JP 2021-71753 A)). In this technology, the management system determines whether or not to continue automated driving of the unmanned driving vehicle, based on a communication state between the unmanned driving support center and the unmanned driving vehicle.

### SUMMARY

When there is trouble in communication between a mobile body and the outside, during unmanned driving of the mobile body such as a vehicle or the like, there are cases in which continuing unmanned driving of the mobile body becomes difficult. Also, there are cases in which the position and so forth of the mobile body is calculated using sensor information acquired by detecting the mobile body from the outside by sensors, in order to cause the mobile body to perform unmanned driving. When calculating the position and so forth of the mobile body using the sensor information, there are cases in which the mobile body is detected from the sensor information in a process of calculating the position and so forth of the mobile body. However, when the sensor information is acquired, in a case in which another object, different from the mobile body that is an object of calculation, is present and overlaps the mobile body that is the object of calculation, detection precision of detecting the mobile body from the sensor information may decrease. Thus, there are cases in which an external factor from the outside, which is different from the mobile body, influences control of unmanned driving of the mobile body.

The present disclosure can be realized in the following aspects.

(1) According to a first aspect of the present disclosure, a control device is provided. The control device for controlling an action of a mobile body that is movable by unmanned driving includes an acquisition unit for acquiring disturbance information regarding an external factor that influences control of the unmanned driving and that is from an outside that is different from the mobile body, and a control unit for changing a control form of the action of the mobile body, using the disturbance information. According to this aspect, the control device can change the control form of the action of the mobile body using the disturbance information, and thus can change the control form to a control form that is appropriate in accordance with the external factor.

(2) In the above aspect, when presence of the external factor is sensed using the disturbance information, in a period in which the mobile body is executing control of an external data mode in which the mobile body moves by the unmanned driving using communication with the outside of the mobile body, the control unit may change the control form to one of an internal data mode in which the mobile body moves by the unmanned driving without using communication with the outside, and a separate communication mode in which the mobile body moves by the unmanned driving, by the mobile body communicating with the outside using a second communication mode that is different from a first communication mode used in the external data mode. According to this aspect, in the period in which the control of the external data mode is executed, when sensing that there is an external factor, using the disturbance information, the control device can change the control form to either the internal data mode or the separate communication mode. Thus, when there is trouble in communication between the mobile body and the outside of the mobile body, the mobile body can continue traveling by the unmanned driving without using communication with the outside, by executing control of the internal data mode. Also, when there is trouble in communication between the mobile body and the outside of the mobile body, the mobile body can communicate with the outside using a communication mode different from the external data mode, by executing control of the separate communication mode. Thus, the mobile body can continue traveling by unmanned driving. That is to say, by the control device changing the control form of the mobile body using the disturbance information, the mobile body can control the action in a state in which the influence of the external factor is reduced.

(3) In the above aspect, the disturbance information may include at least one of communication information, relating to at least one of a communication state between the mobile body and the outside and a communication state among a plurality of external devices that is used for controlling the action of the mobile body and that is installed at a location that is different from that of the mobile body, and detection information, relating to a detection state when the mobile body is detected by a sensor. According to this aspect, the control device can change the control form of the action of the mobile body in accordance with at least one of: at least one of the communication state between the mobile body and the outside of the mobile body, and the communication state between the external devices; and the detection state when the mobile body is detected by the sensor.

(4) In the above aspect, when a degree of influence indicating a magnitude of influence of the external factor on the control of the unmanned driving is compared with a threshold value that is set in advance, and the degree of influence is no smaller than the threshold value, the control unit may cause the mobile body to execute the action that is different from when the degree of influence is smaller than the threshold value. According to this aspect, the control device can change the control form of the action of the mobile body in accordance with the magnitude of the influence of the external factor on the control of unmanned driving.

(5) According to a second aspect of the present disclosure, a control method is provided. The control method for controlling an action of a mobile body that is movable by unmanned driving includes an acquiring process of acquiring disturbance information regarding an external factor that influences control of the unmanned driving of the mobile body and that is from an outside that is different from the mobile body, and a control process of changing a control form of the action of the mobile body using the disturbance information. According to this aspect, the control form of the action of the mobile body can be changed by executing the control method using the disturbance information, and accordingly the control form can be changed to a control form that is appropriate in accordance with the external factor.

(6) According to a third aspect of the present disclosure, a control system is provided. The control system for controlling an action of a mobile body that is movable by unmanned driving includes one or more mobile bodies, an acquisition unit for acquiring disturbance information regarding an external factor that influences control of the unmanned driving of the mobile body and that is from an outside that is different from the mobile body, a sensing unit for sensing presence of the external factor using the disturbance information, and a control unit for changing a control form of the action of the mobile body using the disturbance information when the sensing unit senses the presence of the external factor. According to this aspect, the control system can sense the presence of the external factor using the disturbance information. The control system can then change the control form of the action of the mobile body when sensing the presence of the external factor. Accordingly, the control system can be changed to an appropriate control form in accordance with an external factor.

(7) In the above aspect, when falling under at least one of a first case, a second case, a third case, and a fourth case, the control unit may change the control form, in which, the first case is a case in which an external device that is used for controlling the action of the mobile body, and that is installed at a location different from that of the mobile body, cannot realize a function that is set in advance, due to the external factor, the second case is a case in which the external factor generates trouble in communication among a plurality of the external devices, the third case is a case in which an external sensor installed at a location different from that of the mobile body cannot realize a function that is set in advance, due to the external factor, and the fourth case is a case in which the external factor generates trouble in communication between the mobile body and the external device. According to this aspect, the control form of the action of the mobile body can be changed in a case falling under at least one of the first case, the second case, the third case, and the fourth case.

(8) In the above aspect, the mobile body may further include a mobile body control device that is installed in the mobile body and that controls the action of the mobile body, in which the mobile body control device includes a generating unit that generates one of a control signal that stipulates the action of the mobile body and a moving route of the mobile body, in a period in which control of one of the internal data mode and the separate communication mode is being executed. According to this aspect, in the period in which control of one of the internal data mode and the separate communication mode is being executed, the mobile body control device can control the action of the mobile body by generating one of the control signal and the moving route.

(9) In the above aspect, the mobile body control device may further include an estimation unit that estimates a position of the mobile body, in which the generating unit generates a control signal by acquiring the target control value corresponding to the position that is estimated, using internal data that is stored in advance in a storage unit of the mobile body control device, in which the estimated position of the mobile body and the target control value that is a target value for each parameter included in the control signal are associated with each other. According to this aspect, in the period in which the control of one of the internal data mode and the separate communication mode is being executed, the mobile body control device can estimate the position of the mobile body. The mobile body control device can then generate a control signal by acquiring the target control value corresponding to the estimated position of the mobile body, using the internal data.

(10) In the above aspect, the mobile body control device may further include an estimation unit that estimates a position of the mobile body, in which the generating unit generates at least a part of the moving route from the estimated position to a destination, using internal data that is stored in advance in a storage unit of the mobile body control device and that indicates the destination of the mobile body. According to this aspect, in the period in which the control of one of the internal data mode and the separate communication mode is being executed, the mobile body control device can estimate the position of the mobile body. The mobile body control device can then generate at least a part of the moving route from the estimated position of the mobile body to the destination, using the internal data.

(11) In the above aspect, in a period in which the control of the internal data mode is being executed, the estimation unit may estimate the position of the mobile body using peripheral detection sensor information output from a peripheral detection sensor serving as a sensor that is installed in the mobile body and that is capable of acquiring information regarding a peripheral region of the mobile body. According to this aspect, in the period in which the control of the internal data mode is being executed, the mobile body control device can estimate the position of the mobile body using the peripheral detection sensor information.

(12) In the above aspect, in a period in which the control of the internal data mode is being executed, the estimation unit may estimate the position of the mobile body using position detection sensor information output from a position detection sensor serving as a sensor that is installed in the mobile body and that is capable of acquiring the position of the mobile body. According to this aspect, in the period in which the control of the internal data mode is being executed, the mobile body control device can estimate the position of the mobile body using the position detection sensor information.

(13) In the above aspect, in a period in which the control of the internal data mode is being executed, the estimation unit may acquire time information regarding at least one time of an elapsed time from a point in time that is set in advance, a current time, and an non-reception time that is a time at which information was scheduled to be received but at which the information was not received, and estimate the position of the mobile body by acquiring the position of the mobile body corresponding to the time information, using management information that is stored in advance in a storage unit of the mobile body control device and that indicates a position at which the mobile body is scheduled to be present at a point in time that is set in advance. According to this aspect, in the period in which the control of the internal data mode is being executed, the mobile body control device can estimate the position of the mobile body by acquiring the position of the mobile body corresponding to the time information, using the management information.

(14) In the above aspect, in a period in which the control of the separate communication mode is being executed, the estimation unit may acquire time information regarding at least one time of an elapsed time from a point in time that is set in advance, a current time, and an non-reception time that is a time at which information was scheduled to be received but at which the information was not received, and may estimate the position of the mobile body by acquiring the position of the mobile body corresponding to the time information, using management information that is acquired from the outside using the second communication mode and that indicates a position at which the mobile body is scheduled to exist at point in time that is set in advance. According to this aspect, in the period in which the control of the separate communication mode is being executed, the mobile body control device can acquire the management information from the outside using the second communication mode. The mobile body control device can then estimate the position of the mobile body by acquiring the position of the mobile body corresponding to the time information, using the management information.

(15) In the above aspect, in a period in which the control of the separate communication mode is being executed, the estimation unit may estimate the position of the mobile body using external sensor information that is obtained from the outside using the second communication mode, and that is output from an external sensor serving as a sensor that is installed at a location different from the mobile body, and by which the mobile body is detectable. According to this aspect, in the period in which the control of the separate communication mode is being executed, the mobile body control device can acquire the external sensor information from the outside using the second communication mode. The mobile body control device can then estimate the position of the mobile body using the external sensor information.

(16) In the above aspect, the generating unit may acquire time information regarding at least one time of an elapsed time from a point in time that is set in advance, a current time, and an non-reception time that is a time at which information was scheduled to be received but at which the information was not received, and generate the control signal by acquiring a target control value corresponding to the time information, using internal data that is stored in advance in a storage unit of the mobile body control device, in which the time information and the target control value that is a target value for each parameter included in the control signal are associated with each other. According to this aspect, in a period in which control of one of the internal data mode and the separate communication mode is being executed, the mobile body control device can generate the control signal by acquiring the target control value corresponding to the time information, using the internal data.

(17) In the above aspect, the generating unit may acquire time information regarding at least one time of an elapsed time from a point in time that is set in advance, a current time, and an non-reception time that is a time at which information was scheduled to be received but at which the information was not received, and generate the movement route, using internal data that is stored in advance in a storage unit of the mobile body control device and that is for generating the moving route in accordance with the time information. According to this aspect, in a period in which control of one of the internal data mode and the separate communication mode is being executed, the mobile body control device can generate the moving route in accordance with the time information, using the internal data.

(18) In the above aspect, the generating unit may generate one of the control signal and the moving route using internal data that is stored in advance in a storage unit of the mobile body control device and that is for causing the mobile body to execute an action that is set in advance. According to this aspect, one of the control signal and the moving route can be generated without estimating the position of the mobile body or acquiring time information.

(19) In the above aspect, the generating unit may, in accordance with a moving state of the mobile body, generate one of an emergency evacuation signal including at least one of an evacuation signal for evacuation of the mobile body to an evacuation location that is set in advance and a stop signal for stopping the mobile body, and a non-emergency evacuation signal for continuing movement of the mobile body. According to this aspect, in a period in which control of one of the internal data mode or the separate communication mode is being executed, the mobile body control device can generate the emergency evacuation signal, in accordance with the moving state of the mobile body. Thus, the mobile body control device can move the mobile body to the evacuation location or stop the mobile body. Also, the mobile body control device can generate a non-emergency evacuation signal, in accordance with the moving state of the mobile body. Accordingly, the mobile body control device can cause the mobile body to continue moving, without moving the mobile body to the evacuation location or stopping the mobile body.

(20) In the above aspect, the control unit may change the control form in accordance with a manufacturing process executed with respect to the mobile body. According to this aspect, the control form of the action of the mobile body can be changed in accordance with the manufacturing process executed with respect to the mobile body.

The present disclosure can be realized in various forms other than the control device and the control method that are described above. For example, the present disclosure can be realized in a form of a control system including a control device and a mobile body, a control device, a control system, a method for manufacturing a mobile body, a computer program for realizing a control method for controlling an action of the mobile body, a non-transitory recording medium storing the computer program, and so forth.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a traveling system according to a first embodiment;

FIG. 2 is a flowchart illustrating a processing procedure of travel control of a vehicle according to the first embodiment;

FIG. 3 is a flowchart showing a processing flow in the first embodiment;

FIG. 4 is a diagram illustrating a configuration of a traveling system according to a second embodiment;

FIG. 5 is a flowchart illustrating a processing flow in the second embodiment;

FIG. 6 is a diagram illustrating a configuration of a traveling system according to a third embodiment;

FIG. 7 is a flow chart showing a process of driving control of vehicles according to the third embodiment; and

FIG. 8 is a flowchart illustrating a processing flow in the third embodiment.

### DETAILED DESCRIPTION OF EMBODIMENTS

### A. First Embodiment

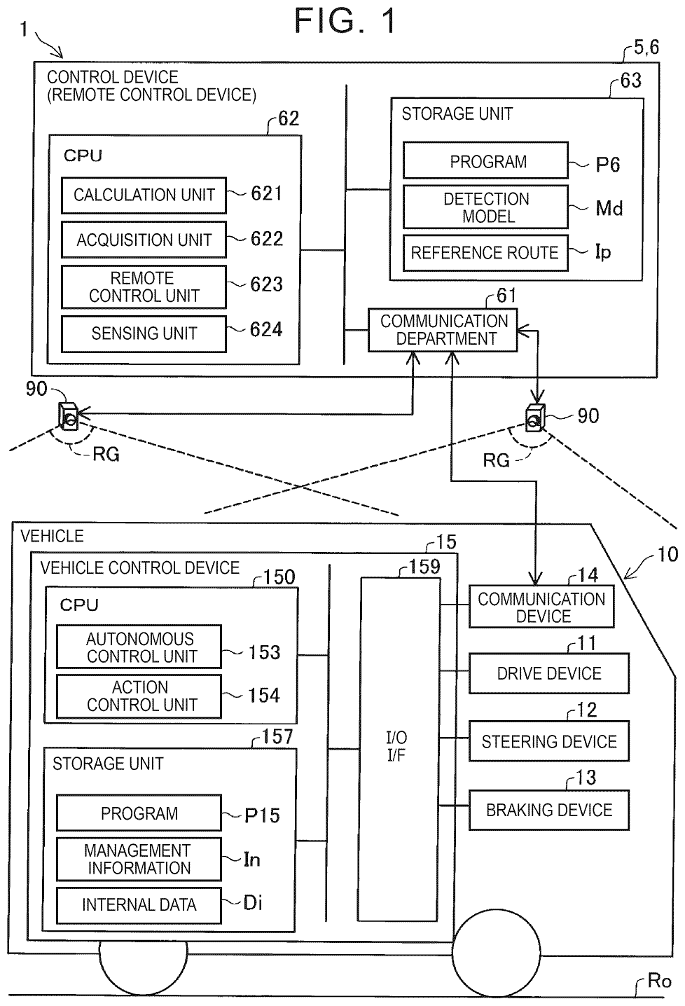

FIG. 1 is a diagram illustrating a configuration of a control system 1 according to a first embodiment. The control system 1 is a system for moving a mobile body without being caused by a traveling operation of an occupant on the mobile body. The control system 1 includes one or more mobile bodies that can be moved by unmanned driving, a sensor that detects the mobile body from the outside, and a remote control device 6 that has a function of the control device 5 that changes the control form of the action of the mobile body using the disturbance information and that remotely controls the action of the mobile body from the outside. The disturbance information is an external factor that affects the control of the unmanned driving of the mobile body, and is information about an external factor different from the mobile body from the outside.

In the present disclosure, the “mobile body” means a movable object, and is, for example, the vehicle 10 or an electric vertical takeoff and landing machine (so-called flying vehicle). In the present embodiment, the mobile body is the vehicle 10. The vehicle 10 may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles 10 include battery electric vehicle (BEV), gasoline-powered vehicles, hybrid electric vehicle, and fuel cell electric vehicle. When the mobile body is other than the vehicle 10, the expressions of “vehicle” and “vehicle” in the present disclosure can be appropriately replaced with “mobile body”, and the expression of “traveling” can be appropriately replaced with “moving”.

The term “unmanned driving” means driving that does not depend on the traveling operation of the passenger. The traveling action means an operation related to at least one of “running”, “turning”, and “stopping” of the vehicle 10. The unmanned driving is realized by automatic or manual remote control using a device that is situated outside the vehicle 10, or by autonomous control of the vehicle 10. The vehicle 10 traveling by the unmanned driving may be occupied by a passenger who does not perform the traveling operation. The passenger who does not perform the traveling operation includes, for example, a person who is simply seated on the seat of the vehicle 10, and a person who performs a work different from the traveling operation such as an assembling action, an inspection action, and a switch action while riding on the vehicle 10. Driving by the traveling action of the occupant is sometimes referred to as “manned driving”. In the present embodiment, the vehicle 10 travels by unmanned driving in a factory where a plurality of manufacturing processes are executed in order to manufacture the vehicle 10. That is, in the present embodiment, the vehicle 10 is produced by transporting the vehicle 10 using the traveling of the vehicle 10 by the unmanned driving in the factory.

Herein, “remote control” includes “full remote control” in which all of the actions of the vehicle 10 are completely determined from the outside of the vehicle 10, and “partial remote control” in which a part of the actions of the vehicle 10 is determined from the outside of the vehicle 10. Further, “autonomous control” includes “fully autonomous control” in which the vehicle 10 autonomously controls its action without receiving any information from a device external to the vehicle 10, and “partially autonomous control” in which the vehicle 10 autonomously controls its action using information received from a device external to the vehicle 10.

The vehicle 10 includes a drive device 11, a steering device 12, a braking device 13, a communication device 14, and a vehicle control device 15. The drive device 11 accelerates the vehicle 10. The steering device 12 changes the traveling direction of the vehicle 10. The braking device 13 decelerates the vehicle 10. The communication device 14 communicates with an external device using wireless communication or the like. The external device is another device different from the vehicle 10 and the other vehicle 10. The communication device 14 is, for example, a wireless communication device.

The vehicle control device 15 controls the action of the vehicle 10. The vehicle control device 15 includes a CPU 150, a storage unit 157, and an input/output interface 159. The input/output interface 159 is used to communicate with various devices mounted on the vehicle 10.

The storage unit 157 of the vehicle control device 15 stores various types of information including various program P15 for controlling the action of the vehicle control device 15, a management information In, and an internal data Di.

The management information In is used to estimate the position of the vehicles 10. The management information In is, for example, information indicating the travel order of the plurality of vehicles 10 traveling in the detection range RG of the external cameras 90. In other words, in this case, the management information In is information indicating the scheduled time for traveling the respective positions in the plant for each vehicle 10, indicating the position where the vehicle 10 is scheduled to exist at a predetermined time point. The management information In is created using, for example, vehicle position information, a transmission history of travel control signals to the vehicle 10, an installation location of the external camera 90, and a manufacturing state of the vehicle 10. The travel control signal is a control signal that stipulates a travel action of the vehicle 10. In the present embodiment, the travel control signal includes the acceleration and the steering angle of the vehicle 10 as parameters. In other embodiments, the travel control signal may include the speed of the vehicle 10 as a parameter instead of or in addition to the acceleration of the vehicle 10.

The internal data Di is data used for the vehicles 10 to travel by unmanned driving without using communication with the outside. In the present embodiment, the internal data Di is data indicating the target accelerations and the target steering angles of the vehicles 10 at the respective positions. In the internal data Di of the present embodiment, the identification information for identifying the position and the travel control information indicating the target acceleration and the target steering angle of the vehicle 10 at the position identified by the identification information are associated with each other. The identification information may be, for example, information regarding an absolute position indicating a current position of the vehicle 10, such as coordinate values of a X, Y, Z in a global coordinate system of a factory, information regarding a relative position between the vehicle 10 and another object, or information indicating a characteristic object for specifying a position. The characteristic object may be, for example, information indicating an object installed only in a workshop where one manufacturing process is performed, or information indicating a landscape of a track Ro on which the vehicles 10 travel. Further, the identification information may include information indicating the orientation of the vehicle 10. In the present embodiment, the internal data Di is used to move the vehicles 10 to a predetermined evacuation location. The evacuation location is, for example, one of a road shoulder and a side road provided on the side of the track Ro. The internal data Di may be a database, or may be data including a calculation expression for executing a predetermined calculation process. In other embodiments, the internal data Di may include data indicative of a target velocity at each position in place of or in addition to a target velocity at each position.

CPU 150 of the vehicle control device 15 functions as an autonomous control unit 153 and an action control unit 154 by expanding various program P15 stored in the storage unit 157. The action control unit 154 controls the action of the actuator that changes the acceleration/deceleration and the steering angle of the vehicle 10, thereby executing the action control of the vehicle 10. The “driving control” is various controls for driving an actuator that performs three functions of “running”, “bending”, and “stopping” of the vehicle 10, such as adjustment of acceleration, speed, and steering angle of the vehicle 10. In the present embodiment, the actuator includes an actuator of the drive device 11, an actuator of the steering device 12, and an actuator of the braking device 13.

The vehicle 10 includes an external data mode and an internal data mode as a control form for traveling by unmanned driving. In the external data mode, the vehicle 10 travels by unmanned driving using communication with the outside. In the internal data mode, the vehicle 10 travels by unmanned driving without using communication with the outside. In the present embodiment, during the period in which the control of the external data mode is executed, the action control unit 154 controls the action of the actuator using the travel control signal received from the remote control device 6, thereby executing the action control of the vehicle 10. In the external data mode, the travel control signal is transmitted from the remote control device 6 to the vehicle 10 at a predetermined cycle.

When it is sensed that there is an external factor during the period in which the control of the external data mode is executed, the vehicle 10 changes the control form. In the present embodiment, the vehicle 10 determines that the presence of an external factor has been sensed when the travel control signal has not been received from the remote control device 6 even after a predetermined stipulated time has elapsed. Then, the vehicle 10 switches the control form from the external data mode and executes the control of the internal data mode.

During the period in which the control of the internal data mode is executed, the autonomous control unit 153 generates an evacuation signal for moving the vehicle 10 to the evacuation location using the management information In and the internal data Di stored in advance in the storage unit 157 of the vehicle control device 15. For example, as in the present embodiment, when the vehicle 10 is produced by transporting the vehicle 10 using the traveling of the vehicle 10 by the unmanned driving in the factory, the evacuation signal is a control signal for causing the vehicle 10 to execute the following action. In this case, the evacuation signal is, for example, a control signal for moving the vehicle 10 out of the manufacturing line by detaching the vehicle 10 from the manufacturing line including the manufacturing location for executing the manufacturing process and the track Ro connecting the plurality of manufacturing locations. In the present embodiment, the evacuation signal includes the acceleration and the steering angle of the vehicle 10 as parameters.

In the present embodiment, in data mode the autonomous control unit 153 estimates the position of the vehicle 10 using the management information In order to generate the evacuation signal. The autonomous control unit 153 estimates the position of the vehicle 10 by acquiring the position of the vehicle 10 corresponding to the present time, for example, using the management information In indicating the scheduled travel time of the respective positions of the factory for each vehicle 10. Then, the autonomous control unit 153 acquires the target acceleration and the target steering angle corresponding to the estimated position of the vehicle 10 using the internal data Di, thereby generating a evacuation signal including the acceleration and the steering angle as parameters. That is, the autonomous control unit 153 has a function of an estimation unit that estimates the position of the vehicle 10 and a function of a generating unit that generates a control signal. Thus, the action control unit 154 controls the action of the actuator using the evacuation signal, thereby moving the vehicle 10 to the evacuation place. At least a part of the functions of the autonomous control unit 153 may be realized by an application prepared in advance.

Note that the autonomous control unit 153 may estimate the position of the vehicle 10 by acquiring the position of the vehicle 10 corresponding to the non-reception time, which is the time at which the travel control signal is scheduled to be received instead of the present time and which is the time at which the travel control signal is not received, using the management information In. When the reference route Ip of the first vehicle 10 and the reference route Ip of the second vehicle 10 differ from each other among the plurality of vehicles 10, the autonomous control unit 153 may estimate the position of the vehicle 10 or generate an evacuation signal using the vehicle identification information identifying the vehicle 10 in addition to the present time.

Note that the configuration of the vehicle 10 is not limited to the above. At least some of the functions of the vehicle control device 15 may be implemented as one function of the remote control device 6, or may be implemented as one function of an external sensor such as the external camera 90.

In the present embodiment, the sensor is a camera 90 (hereinafter, referred to as an external camera 90) as an external sensor provided at a location different from the vehicle 10. The external camera 90 captures the detection range RG including the vehicle 10 from the outside of the vehicle 10, thereby outputting captured images as external sensor information. In order to capture the entire track Ro with one or more external cameras 90, the installation position and the installation count of the external cameras 90 are determined by considering the detection range RG (angle of view) of the external cameras 90 and the like. For example, the external camera 90 may transmit the captured image to the remote control device 6 every time the captured image is acquired, or may transmit the captured image to the remote control device 6 in response to a request from the remote control device 6.

The remote control device 6 is provided at a different location from the vehicle 10. The remote control device 6 is, for example, a server installed in a factory. During the period in which the control of the external data mode is being performed, the remote control device 6 transmits a travel control signal to the vehicle 10, thereby remotely controlling the action of the vehicle 10 from the outside. Further, during the period in which the control of the external data mode is executed, the remote control device 6 senses the presence of an external factor using the disturbance information. When it is sensed that there is an external factor, the remote control device 6 changes the control form from the external data mode to the internal data mode.

The disturbance information includes, for example, communication information. The communication information is information related to a communication state between the vehicle 10 and the outside. The communication information includes, for example, at least one of interference information, weather information, and evaluation information.

The disturbance information is information for determining whether or not communication between the vehicle 10 and the outside is intentionally disturbed. The interference information includes, for example, a detection result of an interference radio wave in an area in which the vehicle 10 travels. The detection result of the interference radio wave includes, for example, information indicating a detection time and a detection location of the interference radio wave.

The weather information is information for determining whether or not the weather condition affects communication between the vehicle 10 and the outside. The weather information includes, for example, information indicating a state of occurrence of lightning strike in an area in which the vehicle 10 travels. The information indicating the occurrence state of the lightning strike includes, for example, information indicating the occurrence time and the occurrence place of the lightning strike. The weather information may include, for example, a detection result of lightning surge, and may include information indicating weather in an area in which the vehicle 10 travels.

The evaluation information is information for determining the presence or absence of an external factor that affects communication between the vehicle 10 and the outside of the vehicle 10. The evaluation information includes, for example, at least one of communication speed information, interruption information, intensity information, response information, reception information, and power supply information as an evaluation result when the communication status between the vehicle 10 and the outside of the vehicle 10 is actually evaluated.

The communication speed information is information related to a communication speed between the vehicle 10 and the outside of the vehicle 10. The communication speed information includes, for example, information indicating a data transfer rate between the vehicle 10 and the outside of the vehicle 10. The communication speed information may include, for example, information indicating whether or not a communication delay occurs in which the communication speed between the vehicle 10 and the outside of the vehicle 10 is less than a predetermined speed.

The interruption information is information indicating an interruption state of communication between the vehicle 10 and the outside of the vehicle 10. The interruption information includes, for example, information indicating a time at which communication between the vehicle 10 and the outside of the vehicle 10 is interrupted. The interruption information may include, for example, information indicating a length of time when communication between the vehicle 10 and the outside of the vehicle 10 is interrupted, and may include information indicating the number of times of interruption of communication between the vehicle 10 and the outside of the vehicle 10 within a predetermined time.

The response information is information indicating that there is no response by the target device. The response information is, for example, information indicating that, when the vehicle 10 communicably connected to the external device transmits a signal to the external device, it is detected that there is no response by the external device. The external device is a device used to control the action of the vehicle 10, and is provided at a different location from the vehicle 10. The external device is, for example, a remote control device 6 and an external camera 90 as an external sensor. The response information may be information indicating that the vehicle 10 has detected that there is no response when an external device communicably connected to the vehicle 10 transmits a signal to the vehicle 10.

The reception information is information indicating that information is not transmitted from the target device. The reception information is, for example, information indicating that the vehicle 10 has detected that information scheduled to be transmitted from the external device to the vehicle 10 is not transmitted from the external device. In this case, the information scheduled to be transmitted from the external device to the vehicle 10 is, for example, a travel control signal and external sensor information. The reception information may be information indicating that the external device has detected that information scheduled to be transmitted from the vehicle 10 to the external device is not transmitted from the vehicle 10. In this case, the information scheduled to be transmitted from the vehicle 10 to the external device is internal sensor information output from the internal sensor, and is, for example, a traveling speed and a pinion angle of the vehicle 10.

The power supply information is information indicating that the target device is not powered on. The power supply information is, for example, information indicating that the external camera 90 is not powered on. The power supply information may be information indicating that the remote control device 6 is not powered on.

The remote control device 6 includes a communication unit 61, a storage unit 63, and a CPU 62. In the remote control device 6, the communication unit 61, the storage unit 63, and CPU 62 are bi-directionally communicably connected via a bus or the like.

The communication unit 61 of the remote control device 6 communicably connects the remote control device 6 to other devices other than the remote control device 6. The communication unit 61 of the remote control device 6 is, for example, a wireless communication device.

The storage unit 63 of the remote control device 6 stores various types of information including various program P6 for controlling the action of the remote control device 6, the detection model Md, and the reference route Ip. The detection model Md and the reference route Ip will be described later.

CPU 62 of the remote control device 6 functions as a calculation unit 621, an acquisition unit 622, a sensing unit 624, and a remote control unit 623 by expanding various program P6 stored in the storage unit 63.

The calculation unit 621 acquires the vehicle position information by calculating the position and the direction of the vehicle 10. The vehicle position information is position information that is a basis for generating a travel control signal. In the present embodiment, the vehicle position information includes the position and orientation of the vehicle 10 in the reference coordinate system of the factory. In the present embodiment, the reference coordinate system of the factory is a global coordinate system, and any position in the factory can be represented by X, Y, Z coordinates in the global coordinate system. In the present embodiment, the external sensor is a camera installed in a factory, and a captured image is output from the external sensor as a detection result. That is, the calculation unit 621 acquires the vehicle position information using the captured image acquired from the camera that is the external sensor. Hereinafter, a camera as an external sensor is referred to as an “external camera 90”.

Specifically, the calculation unit 621 acquires the position of the vehicle 10 by, for example, detecting the external shape of the vehicle 10 from the captured image, calculating the coordinate system of the captured image, that is, the coordinates of the positioning point of the vehicle 10 in the local coordinate system, and converting the calculated coordinates into the coordinates in the global coordinate system. The outline of the vehicle 10 included in the captured image can be detected by, for example, inputting the captured image into a detection model Md using artificial intelligence. The detection model Md is prepared in the control system 1 or outside the control system 1, for example, and stored in advance in the storage unit 63 of the remote control device 6. The detection model Md may be, for example, a learned machine learning model learned to implement either semantic segmentation or instance segmentation. As the machine learning model, for example, a convolutional neural network (hereinafter referred to as a CNN) learned by supervised learning using a learning dataset can be used. The training data set includes, for example, a plurality of training images including the vehicle 10, and a correct label indicating which of an area indicating the vehicle 10 and an area indicating other than the vehicle 10 each area in the training image is. When CNN is learned, the parameters of CNN are preferably updated by back propagation so as to reduce the error between the output by the detection model Md and the correct label. Further, the calculation unit 621, for example, by utilizing the optical flow method, by estimating based on the orientation of the movement vector of the vehicle 10 calculated from the positional change of the feature points of the vehicle 10 between the frames of the captured image, the vehicle 10 orientation can be obtained. For example, the calculation unit 621 may acquire the direction of the vehicle 10 using an output result of a yaw rate sensor or the like mounted on the vehicle 10.

The acquisition unit 622 acquires disturbance information. In the present embodiment, the acquisition unit 622 acquires interference information, which is a kind of communication information, as the disturbance information.

The sensing unit 624 senses the presence of an external factor using the disturbance information. In the present embodiment, the sensing unit 624 determines whether or not communication between the vehicle 10 and the outside of the vehicle 10 is disturbed using the disturbance information. When determining that communication between the vehicle 10 and the outside of the vehicle 10 is disturbed, the sensing unit 624 detects that there is an external factor.

The remote control unit 623 causes the vehicle 10 to perform different actions in accordance with the presence or absence of an external factor. When the sensing unit 624 detects that there is an external factor, the remote control unit 623 causes the vehicle 10 to continue traveling without changing the control form of the action of the vehicle 10. In the present embodiment, when the sensing unit 624 determines that the communication between the vehicle 10 and the outside of the vehicle 10 is not disturbed, the remote control unit 623 continues the control in the external data mode.

In the external data mode, the remote control unit 623 generates a travel control signal and transmits the generated travel control signal to the vehicle 10. In order to generate the travel control signal, the remote control unit 623 first determines a target position to which the vehicle 10 should be headed next. In the present embodiment, the target position is represented by the coordinates of X, Y, Z in the global coordinate system. In the storage unit 63 of the remote control device 6, a reference route Ip that is a route on which the vehicles 10 should travel is stored in advance. The route is represented by a node indicating a starting point, a node indicating a passing point, a node indicating a destination, and a link connecting the respective nodes. The remote control unit 623 determines a target position to which the vehicle 10 should be directed next using the vehicle position information and the reference route Ip. The remote control unit 623 determines the target position on the reference route Ip ahead of the current position of the vehicle 10. The remote control unit 623 generates a travel control signal for causing the vehicle 10 to travel toward the determined target position. The remote control unit 623 calculates the traveling speed of the vehicle 10 from the transition of the position of the vehicle 10, and compares the calculated traveling speed with the target speed. As a whole, the remote control unit 623 determines acceleration so that the vehicle 10 accelerates when the traveling speed is lower than the target speed, and determines acceleration so that the vehicle 10 decelerates when the traveling speed is higher than the target speed. Further, when the vehicle 10 is located on the reference route Ip, the remote control unit 623 determines the steering angle and the acceleration so that the vehicle 10 does not deviate from the reference route Ip, and determines the steering angle and the acceleration so that the vehicle 10 returns to the reference route Ip when the vehicle 10 is not located on the reference route Ip, in other words, when the vehicle 10 deviates from the reference route Ip. In this way, the remote control unit 623 generates a travel control signal including the acceleration and the steering angle of the vehicle 10 as parameters.

On the other hand, when the sensing unit 624 detects that there is an external factor, the remote control unit 623 changes the control form of the action of the vehicle 10 using the disturbance information. In the present embodiment, when the sensing unit 624 determines that communication between the vehicle 10 and the outside is disturbed, the remote control unit 623 changes the control form from the external data mode to the internal data mode. At this time, the remote control unit 623 stops the transmission of the travel control signal to the vehicle 10, thereby changing the control form of the action of the vehicle 10 from the external data mode to the internal data mode.

Note that the configuration of the remote control device 6 is not limited to the above. Each unit of the remote control device 6 may be configured separately by a plurality of devices, for example. Each unit of the remote control device 6 may be realized by, for example, cloud computing constituted by one or more computers. Further, at least a part of the functions of the remote control device 6 may be realized as one function of the vehicle control device 15, or may be realized as one function of an external sensor such as the external camera 90.

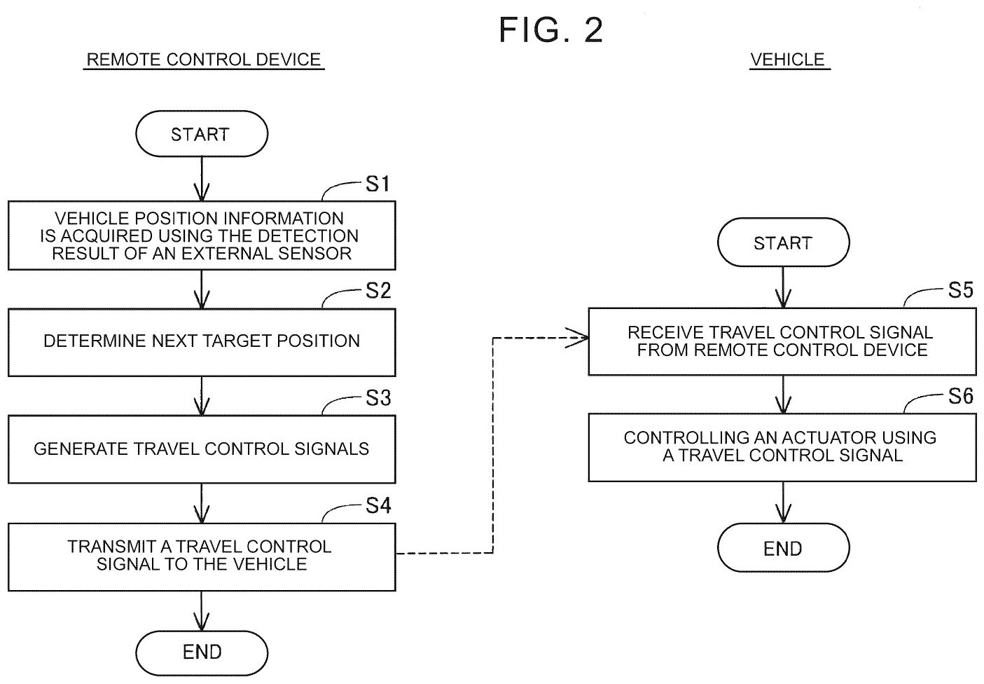

FIG. 2 is a flowchart illustrating a processing procedure of travel control of the vehicle 10 according to the first embodiment. FIG. 2 illustrates a processing procedure in a period in which the control of the external data mode is executed. In S1, the calculation unit 621 acquires the vehicle position information using the detection result outputted from the external sensor which is a sensor located outside the vehicle 10. In the present embodiment, the calculation unit 621 acquires the vehicle position information using the captured image acquired from the external camera 90. In S2, the remote control unit 623 determines the target position to which the vehicle 10 is to be directed next, using the vehicle position information and the reference route Ip. At S3, the remote control unit 623 generates a travel control signal for causing the vehicle 10 to travel toward the determined target position. At S4, the remote control unit 623 transmits the generated travel control signal to the vehicles 10. During the period in which the control of the external data mode is executed, the remote control device 6 repeats the acquisition of the vehicle position information, the determination of the target position, the generation of the travel control signal, the transmission of the travel control signal, and the like at a predetermined cycle. In S5, the action control unit 154 of the vehicle control device 15 mounted on the vehicle 10 receives the travel control signal transmitted from the remote control device 6. In S6, the vehicle 10 controls the actuator of the vehicle 10 using the received travel control signal, thereby causing the vehicle 10 to travel at the acceleration and the steering angle represented by the travel control signal. During the period in which the control of the external data mode is executed, the vehicle 10 repeats the reception of the travel control signal and the control of the actuator of the vehicle 10 at a predetermined cycle.

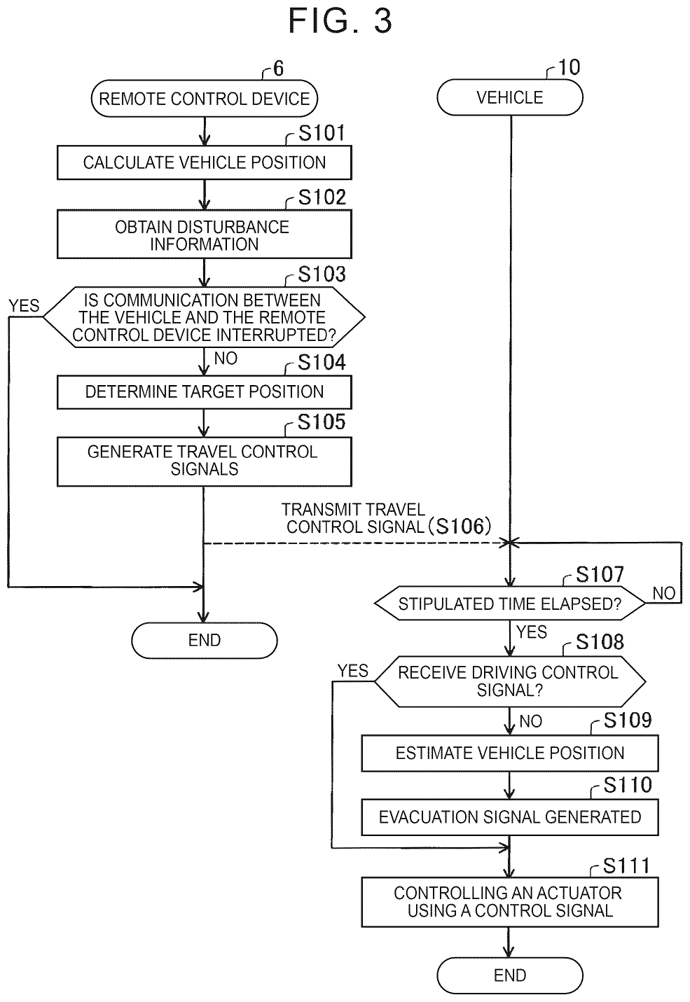

FIG. 3 is a flowchart illustrating a processing flow in the first embodiment. The process flow illustrated in FIG. 3 is repeatedly executed at predetermined time intervals, for example, in a period from the start point to at least one of the change point and the end point. The start time point is a time point at which the vehicle 10 to be controlled starts traveling by remote control. The change time point is a time point when the control form of the action of the vehicle 10 is changed from the external data mode to the internal data mode. The ending time point is a time point at which the vehicle 10 to be controlled reaches the destination located at the end of the reference route Ip.

In S101, the calculation unit 621 calculates the position of the vehicle 10 using the captured images. In S102, the acquisition unit 622 acquires the interference information. In S103, the sensing unit 624 determines whether or not communication between the vehicles 10 and the remote control device 6 is disturbed using the disturbance information, and detects that there is an external factor.

When it is determined that the communication between the vehicles 10 and the remote control device 6 is not disturbed, that is, when the sensing unit 624 does not detect that there is an external factor (S103:No), the remote control unit 623 executes S104. In S104, the remote control unit 623 determines the target position to which the vehicle 10 is to be directed next using the vehicle position information and the reference route Ip. In S105, the remote control unit 623 generates a travel control signal for causing the vehicle 10 to travel toward the determined target position. In S106, the remote control unit 623 transmits a travel control signal to the vehicles 10. On the other hand, when it is determined that the communication between the vehicle 10 and the remote control device 6 is disturbed, that is, when the sensing unit 624 detects that there is an external factor (S103:Yes), the remote control unit 623 ends the process flow without transmitting the travel control signal to the vehicle 10.

When the predetermined stipulated period of time has elapsed (S107:Yes), and when the travel control signal is not received from the remote control device 6 (S108:No), S109 is executed. In S109, the autonomous control unit 153 of the vehicle control device 15 mounted on the vehicle 10 estimates the position of the vehicle 10 using the management information In. In S110, the autonomous control unit 153 acquires the target acceleration and the target steering angle corresponding to the estimated position of the vehicle 10 in the internal-data Di, thereby generating a evacuation signal including the acceleration and the steering angle as parameters.

In S111, the action control unit 154 controls the actuator using the control signal. Specifically, when the stipulated period has elapsed (S107:Yes), when the travel control signal is received from the remote control device 6 (S108:Yes), the action control unit 154 controls the actuator using the travel control signal received from the remote control device 6. Accordingly, the vehicle 10 is caused to travel at the acceleration and the steering angle represented by the travel control signal. On the other hand, when the stipulated period of time has elapsed (S107:Yes), when the travel control signal has not been received (S108:No), the action control unit 154 controls the actuator using the evacuation signal generated by the autonomous control unit 153. Thus, the action control unit 154 moves the vehicle 10 to the evacuation location by causing the vehicle 10 to travel at the acceleration and the steering angle represented by the evacuation signal.

According to the first embodiment, since the remote control device 6 can change the control form of the action of the vehicle 10 using the disturbance information, it is possible to change the control form to an appropriate control form in accordance with an external factor. Specifically, the remote control device 6 can determine whether or not communication between the vehicle 10 and the remote control device 6 is disturbed by acquiring the disturbance information, and can sense that there is an external factor. Then, when it is determined that the communication between the vehicle 10 and the remote control device 6 is disturbed, that is, when it is sensed that there is an external factor, the remote control device 6 can change the control form of the action of the vehicle 10 by stopping the transmission of the travel control signal to the vehicle 10, and move the vehicle 10 to the evacuation place. That is, the remote control device 6 can determine whether or not to continue the control of the unmanned driving according to the type of the external factor, or change the control form to an appropriate control form according to the external factor, when the external factor from the outside different from the vehicle 10 such as the interference radio wave affects the control of the unmanned driving.

Further, according to the first embodiment, the remote control device 6 can change the control form from the external data mode to the internal data mode when it is determined that there is an external factor using the disturbance information. In this way, when the communication between the vehicle 10 and the outside of the vehicle 10 is hindered due to an external factor such as a disturbance radio wave, the vehicle 10 can travel by unmanned driving without using the communication with the outside. That is, by the remote control device 6 changing the control form of the vehicle 10 using the disturbance information, the vehicle 10 can control the action in a state in which the influence of the external factor is reduced.

Further, according to the first embodiment, the remote control device 6 can change the control form of the action of the vehicle 10 according to the communication state between the vehicle 10 and the remote control device 6 by using the interference information which is a kind of communication information.

Further, according to the first embodiment, the control system 1 can cause the vehicle 10 to travel in a factory by remote control. Therefore, the control system 1 can move the vehicle 10 in the factory without using a conveyance facility such as a crane or a conveyor. The vehicle 10 may be driven by an unmanned driving other than the factory.

Further, according to the first embodiment, the vehicle control device 15 can estimate the position of the vehicle 10 by acquiring the position of the vehicle 10 corresponding to the present time using the management information In indicating the scheduled traveling time of the respective positions for each vehicle 10 during the period in which the control of the internal-data mode is executed. The vehicle control device 15 acquires the target acceleration and the target steering angle corresponding to the estimated position of the vehicle 10 using the data internal data Di indicating the target acceleration and the target steering angle of the vehicle 10 at the respective positions, thereby generating a evacuation signal including the acceleration and the steering angle as parameters. As a result, the vehicle control device 15 controls the actuator using the generated evacuation signal, so that the vehicle can continue traveling by unmanned driving without using communication with the outside.

### B. Second Embodiment

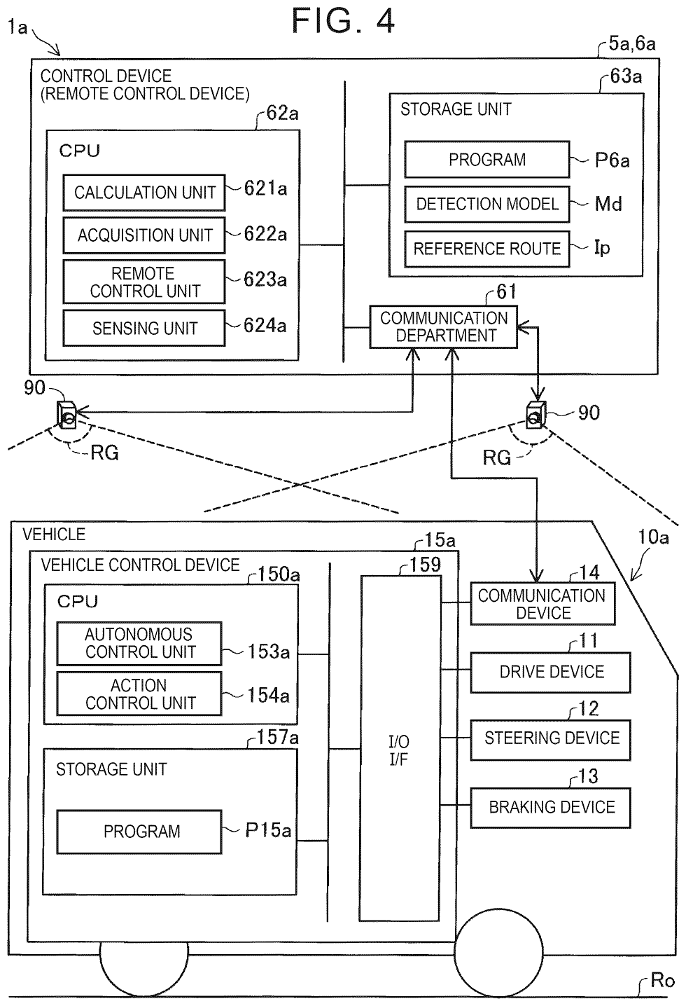

FIG. 4 is a diagram illustrating a configuration of a control system 1a according to the second embodiment. The control system 1a includes one or more vehicle 10a, an external camera 90 as a sensor for detecting the vehicle 10a from the outside, and a remote control device 6a as a control device 5a for changing a control form of the action of the vehicle 10a using the disturbance information. This embodiment differs from the first embodiment in some of the types of disturbance information acquired by the remote control device 6a and the methods of controlling the action of the vehicle 10a. The same components as those in the first embodiment are denoted by the same reference numerals, and the description thereof is omitted.

The remote control device 6a includes a communication unit 61, a storage unit 63a, and a CPU 62a. The storage unit 63a of the remote control device 6a stores various types of information including various programming P6a for controlling the action of the remote control device 6a, the detection model Md, and the reference route Ip. CPU 62a of the remote control device 6a functions as the acquisition unit 622a, the calculation unit 621a, the sensing unit 624a, and the remote control unit 623a by expanding the various programming P6a stored in the storage unit 63a.

The acquisition unit 622a acquires detected information as disturbance information. In the present embodiment, the detection information is information related to a detection state when the external camera 90 detects the vehicle 10a. In the present embodiment, the detection information is information indicating the degree of overlap when another object (hereinafter referred to as an obstacle) that differs from the vehicle 10a of the detection target is overlapped on the vehicle 10a of the detection target in the captured image. The degree of overlap is information of a numerical value indicating the degree of overlap between 10a of vehicles to be detected and the obstacle. The degree of overlap is, for example, a ratio of the number of pixels in which the vehicle 10a to be detected and the obstacle overlap with each other with respect to the number of pixels representing the vehicle 10a to be detected in the captured images. The obstacle may be a mobile body or a stationary object. A mobile body is an object that can approach a vehicle 10a by moving. The mobile body is, for example, an organism such as a human or an animal, another vehicle 10a that differs from the vehicle 10a to be detected, or an unmanned guided vehicle (AGV). A stationary object is an object which is arranged naturally or artificially in the track Ro. The stationary object is, for example, a plant such as a tree that changes in size due to a manufacturing facility capable of appropriately changing the arrangement, an instrument such as a road cone and a signboard arranged on a track Ro, a flying object such as fallen leaves flying in a track Ro, and growing.

The sensing unit 624a detects the presence of an external factor using the detection information. In the present embodiment, the sensing unit 624a detects the presence of an external factor using the degree of influence calculated on the basis of the detection information. The degree of influence indicates a magnitude at which an external factor affects the control of the unmanned driving. In the present embodiment, the degree of influence is determined by the degree of overlap as the detection information. The greater the degree of overlap, the greater the degree of influence, and the smaller the degree of overlap, the smaller the degree of influence. When the degree of influence determined by the degree of overlap (hereinafter referred to as the degree of overlap influence) is equal to or greater than a predetermined threshold value (hereinafter referred to as the overlap threshold value), the sensing unit 624a detects that there is an external factor.

When the sensing unit 624a does not detect that there is an external factor, the calculation unit 621a calculates the position of the vehicle 10a using the captured images. On the other hand, when the sensing unit 624a detects that there is an external factor, the calculation unit 621a ends the process related to the position calculation of the vehicle 10a without calculating the position of the vehicle 10a. In the present embodiment, when the degree of overlap is less than the overlap thresholds, the calculation unit 621a calculates the position of the vehicle 10a using the captured images. On the other hand, when the overlap degree is equal to or greater than the overlap threshold value, the calculation unit 621a ends the process related to the position calculation of the vehicle 10a without calculating the position of the vehicle 10a.

The remote control unit 623a causes the vehicle 10a to perform various actions according to the degree of influence. In the present embodiment, when the overlap degree of influence is less than the overlap threshold, the remote control unit 623a determines that the detection accuracy when detecting the vehicle 10a from the captured images is not reduced, and continues the traveling of the vehicle 10a. On the other hand, when the overlap degree of influence is equal to or greater than the overlap threshold value, the remote control unit 623a determines that the detection accuracy when detecting the vehicle 10a from the captured images is deteriorated, and transmits a stopping instruction to the vehicle 10a. Thus, the remote control device 6a stops the vehicle 10a.

The vehicle control device 15a mounted on the vehicle 10a includes an input/output interface 159, a storage unit 157a, and a CPU 150a. The storage unit 157a of the vehicle control device 15a stores various types of information including various types of program P15a for controlling the action of the vehicle control device 15a. CPU 150a of the vehicle control device 15a functions as an autonomous control unit 153a and an action control unit 154a by expanding various program P15a stored in the storage unit 157a. When receiving the stop instruction from the remote control device 6a, the autonomous control unit 153a generates a stop signal for stopping the vehicle 10a. In the present embodiment, the autonomous control unit 153a determines the acceleration so that the traveling speed of the vehicle 10a decelerates, thereby generating a stopping signal including the acceleration as a parameter. Accordingly, the action control unit 154a controls the action of the actuator using the stop signal, thereby stopping 10a of vehicles. In order to stop the vehicle 10a at a desired location, the stop signal may include the steering angle of the vehicle 10a as a parameter. The deactivation signal may also be generated at the remote control device 6a and transmitted to the vehicle 10a.

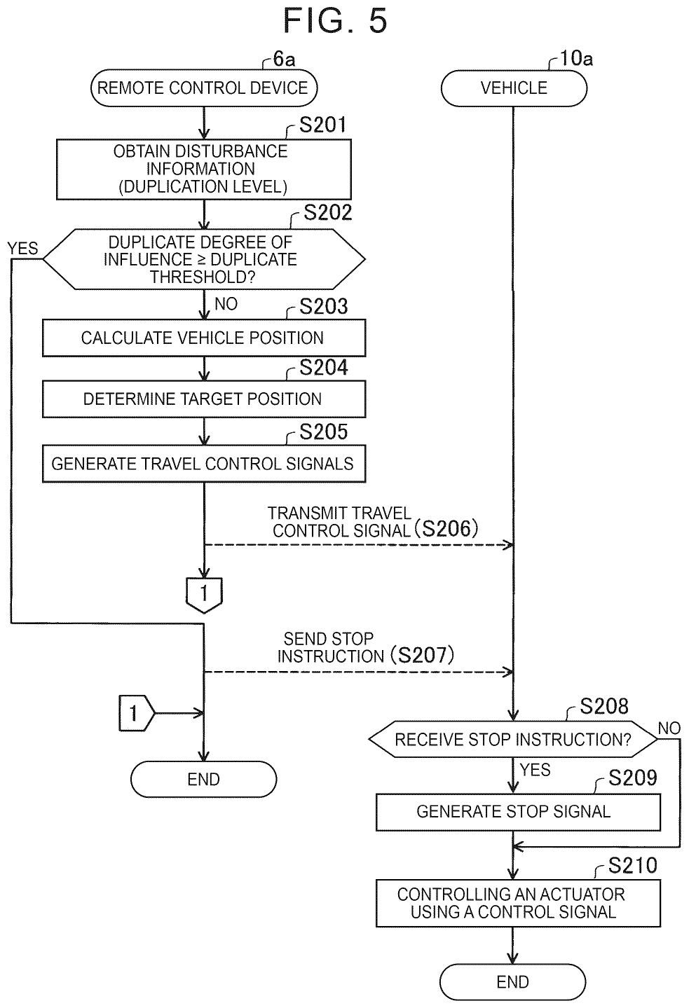

FIG. 5 is a flowchart illustrating a processing flow in the second embodiment. For example, the process flow illustrated in FIG. 5 is repeatedly executed at predetermined time intervals in a period from the start time to at least one of the instruction time point and the end time point. The instruction time point is a time point at which the stop instruction is transmitted from the remote control device 6a to the vehicle 10a so that the control form of the vehicle 10a is changed.

In S201, the acquisition unit 622a of the remote control device 6a acquires the degree of overlap. In S202, the sensing unit 624a detects the presence of an external factor by comparing the overlap degree of influence with the overlap thresholds. When the overlap degree of influence is less than the overlap threshold, that is, when the sensing unit 624a does not detect that there is an external factor (S202:No), in S203, the calculation unit 621a calculates the position of the vehicle 10a using the captured images. In S204, the remote control unit 623a uses the vehicle position information and the reference route Ip to determine a target position to which the vehicle 10a is to be directed next. In S205, the remote control unit 623a generates a travel control signal for causing the vehicle 10a to travel toward the determined target position. In S206, the remote control unit 623a transmits a travel control signal to the vehicle 10a. On the other hand, when the overlap degree of influence is equal to or greater than the overlap threshold value, that is, when the sensing unit 624a detects that there is an external factor (S202:Yes), the remote control unit 623a transmits a stopping instruction to the vehicle 10a in S207.

When the vehicle 10a receives the stop instruction (S208:Yes), in S209, the autonomous control unit 153a of the vehicle control device 15a mounted on the vehicle 10a generates a stop signal. In S210, the action control unit 154a controls the actuator using the control signal. Specifically, when the stopping instruction is not received (S208:No), the action control unit 154a controls the actuator using the received travel control signal, and thereby causes the vehicle 10a to travel at the acceleration and the steering angle represented by the travel control signal. On the other hand, when the stop instruction is received (S208:Yes), the action control unit 154a controls the actuator using the stop signal, thereby stopping the vehicle 10a.

According to the second embodiment, the remote control device 6a can acquire, as the disturbance information, a degree of overlap that is a kind of detected information. Then, the remote control device 6a can determine whether or not the accuracy of detecting the vehicle 10a from the captured images is deteriorated by comparing the overlap degree of influence determined by the overlap degree of influence with the overlap thresholds, and can sense that there is an external factor. In other words, in the captured image, the remote control device 6a can determine that the detection accuracy at the time of detecting the vehicle 10a from the captured image is deteriorated when the obstacle overlaps the captured image so as to cover the vehicle 10a to be sensed over a predetermined area or more, and detect that there is an external factor. Then, the remote control device 6a can change the control form of the action of the vehicle 10a and stop the vehicle 10a when it is determined that the detection accuracy when the vehicle 10a is detected from the captured images is deteriorated, that is, when it is sensed that there is an external factor. That is, the remote control device 6a can change the control form of the action of the vehicle 10a according to the magnitude of the effect of the obstacle as an external factor on the control of the unmanned driving.

Further, according to the second embodiment, the remote control device 6a can change the control form of the action of the vehicle 10a according to the detection state when the vehicle 10a is detected by the external camera 90 by using the detection information.

The calculation unit 621a may calculate the position of the vehicle 10a using the captured images even when the overlap degree is equal to or greater than the overlap threshold. In this case, for example, the remote control unit 623a may determine that there is a possibility that the detection accuracy at the time of detecting the vehicle 10a from the captured images is deteriorated, sense that there is an external factor, and transmit the stopping instruction to the vehicle 10a without generating the travel control signal using the vehicle position information. Even in such a configuration, the remote control device 6a can determine whether or not the detection accuracy when detecting the vehicle 10a from the captured image is deteriorated, and change the control form of the action of the vehicle 10a according to the detection accuracy when detecting the vehicle 10a from the captured image.

Further, the detection information may be, for example, information indicating whether or not an obstacle is present on 10a of the vehicle to be detected in the external sensor information. In this case, the remote control device 6a determines, for example, that the detection accuracy when detecting the vehicle 10a from the captured images is deteriorated when an obstacle is present overlapping on the vehicle 10a to be detected in the external sensor information, and senses that there is an external factor. On the other hand, when an obstacle does not overlap and exist on the vehicle 10a to be detected in the external sensor information, the remote control device 6a determines that the detection accuracy when detecting the vehicle 10a from the captured images is not deteriorated. Even in such a configuration, the remote control device 6a can determine whether or not the detection accuracy when detecting the vehicle 10a from the captured image is deteriorated, and change the control form of the action of the vehicle 10a according to the detection accuracy when detecting the vehicle 10a from the captured image.

### C. Third Embodiment

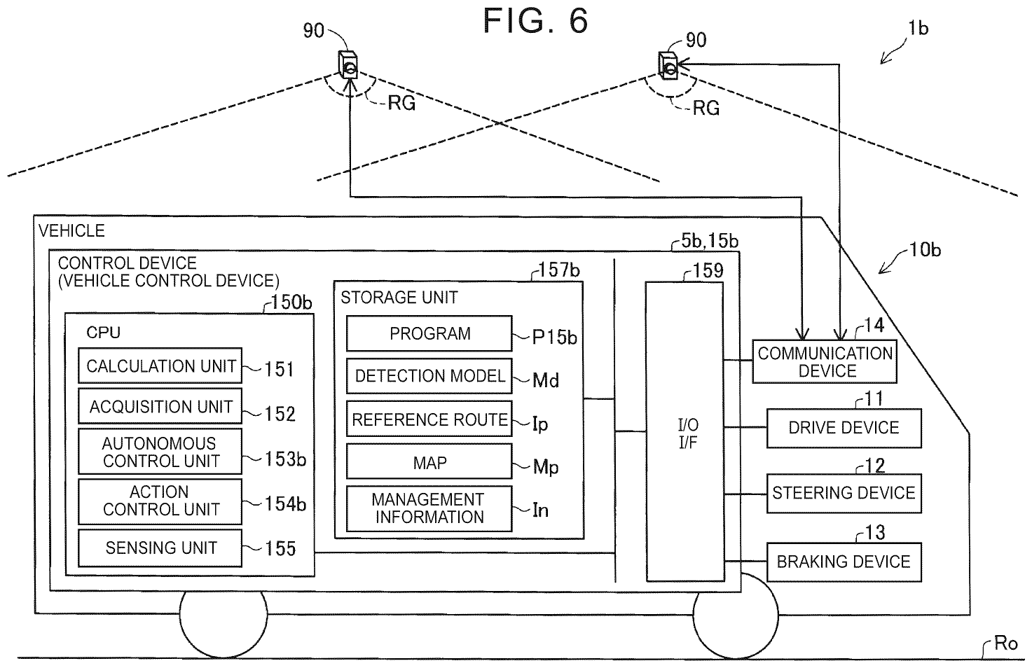

FIG. 6 is a diagram illustrating a configuration of a control system 1b according to a third embodiment. The control system 1b includes one or more vehicle 10b equipped with a vehicle control device 15b as a control device 5b for changing the control form of the action of the vehicle 10b using the disturbance information, and an external camera 90 as a sensor for detecting the vehicle 10b from the outside. In the present embodiment, the vehicle control device 15b changes the control form of the action of the vehicle 10 using the disturbance information. The same components as those in the first embodiment are denoted by the same reference numerals, and the description thereof is omitted.

The vehicle control device 15b includes a CPU 150b, a storage unit 157b, and an input/output interface 159. The storage unit 157b of the vehicle control device 15b stores various types of information including various program P15b for controlling the action of the vehicle control device 15b, the detection model Md, the reference route Ip, and the map Mp. The map Mp is an internal data Di indicating the position of the evacuation location in the factory. In the map Mp, the position of the evacuation location in the factory is represented by the coordinates of X, Y, Z in the global coordinate system of the factory.

CPU 150b of the vehicle control device 15b functions as a calculation unit 151, an acquisition unit 152, a sensing unit 155, an autonomous control unit 153b, and an action control unit 154b by expanding various program P15b stored in the storage unit 157b.

The calculation unit 151 calculates the position of the vehicle 10b using the captured images acquired from the external cameras 90.

The acquisition unit 152 acquires disturbance information. In the present embodiment, the acquisition unit 152 acquires communication speed information indicating a communication speed between the vehicle 10b and the external camera 90 as the disturbance information.

The sensing unit 155 detects the presence of an external factor using the communication speed information. In the present embodiment, the sensing unit 155 detects the presence of an external factor by determining whether or not communication between the vehicle 10b and the external camera 90 is disturbed using the degree of influence calculated based on the communication speed information. In the present embodiment, the degree of influence is a communication speed specified by the communication speed information, and is determined by the communication speed between the vehicle 10 and the external camera 90. The higher the communication speed between the vehicle 10 and the external camera 90, the smaller the degree of influence, and the lower the communication speed between the vehicle 10b and the external camera 90, the greater the degree of influence. When the degree of influence (hereinafter, speed influence) determined by the communication speed is equal to or greater than a predetermined threshold (hereinafter, speed threshold), the sensing unit 155 determines that communication between the vehicle 10b and the external camera 90 is disturbed, and detects that there is an external factor.

The autonomous control unit 153b causes the vehicle 10b to perform various actions according to the degree of influence. In the present embodiment, when the speed degree of influence is less than the speed threshold, the autonomous control unit 153b determines that the communication between the vehicle 10b and the outside is not disturbed, and continues the control in the external data mode. On the other hand, when the speed degree of influence is equal to or higher than the speed threshold, the autonomous control unit 153b determines that communication between the vehicle 10b and the outside is disturbed, and changes the control form from the external data mode to the internal data mode. Also in the present embodiment, the autonomous control unit 153b generates an evacuation signal including the acceleration/steering angle as a parameter during the duration of executing the control of the internal data mode.

During the time when the control of the internal-data mode is executed, the autonomous control unit 153b first acquires the position of the vehicle 10b corresponding to the present time using the management information In indicating the scheduled traveling time of the respective positions of the factory for each vehicle 10b. Thus, the autonomous control unit 153b estimates the position of the vehicle 10b. Next, the autonomous control unit 153 acquires the position of the evacuation location serving as the destination using the estimated position of the vehicle 10b and the map Mp stored in the storage unit 157b. When there are a plurality of evacuation locations in the factory, the autonomous control unit 153b selects, for example, the location of the evacuation location closest to the location of the vehicle 10b estimated as the current location of the vehicle 10b as the destination. Next, the autonomous control unit 153 generates an evacuation route from the estimated position of the vehicle 10b to the position of the evacuation location selected as the destination. Next, the autonomous control unit 153b determines any position on the generated evacuation route as the target position. The autonomous control unit 153b generates an evacuation signal for moving the vehicle 10b toward the determined target position. That is, the autonomous control unit 153b has a function of an estimation unit and a function of a generating unit that generates a moving route. Instead of the evacuation route, the autonomous control unit 153b may generate a partial route to the target position between the estimated position of the vehicle 10b and the position of the evacuation location selected as the destination.

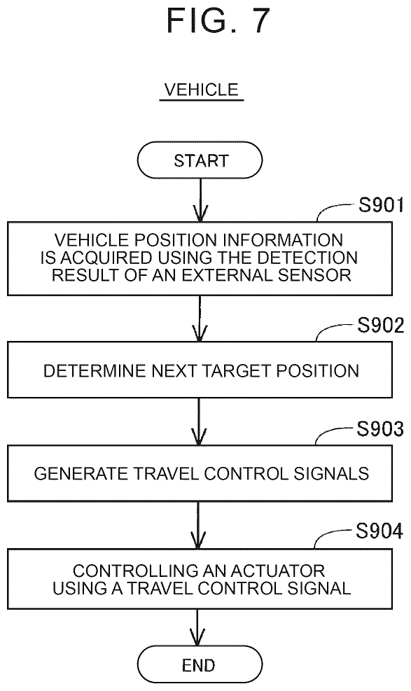

FIG. 7 is a flow chart showing a process sequence of travel control of the vehicle 10b according to the third embodiment. FIG. 7 illustrates a processing procedure in a period in which the control of the external data mode is executed. In S901, the calculation unit 151 of the vehicle control device 15b mounted on the vehicle 10b acquires the vehicle position information using the detection result outputted from the external camera 90. In S902, the autonomous control unit 153b determines a target position to which the vehicle 10b is to be directed next. In S903, the autonomous control unit 153b generates a travel control signal for causing the vehicle 10b to travel toward the determined target position. In S904, the action control unit 154b causes the vehicle 10b to travel in accordance with the acceleration and the steering angle indicated by the generated travel control signal. During the execution of the control of the external data mode, the vehicle 10b repeatedly acquires the vehicle position information, determines the target position, generates the travel control signal, and controls the actuator at a predetermined cycle.

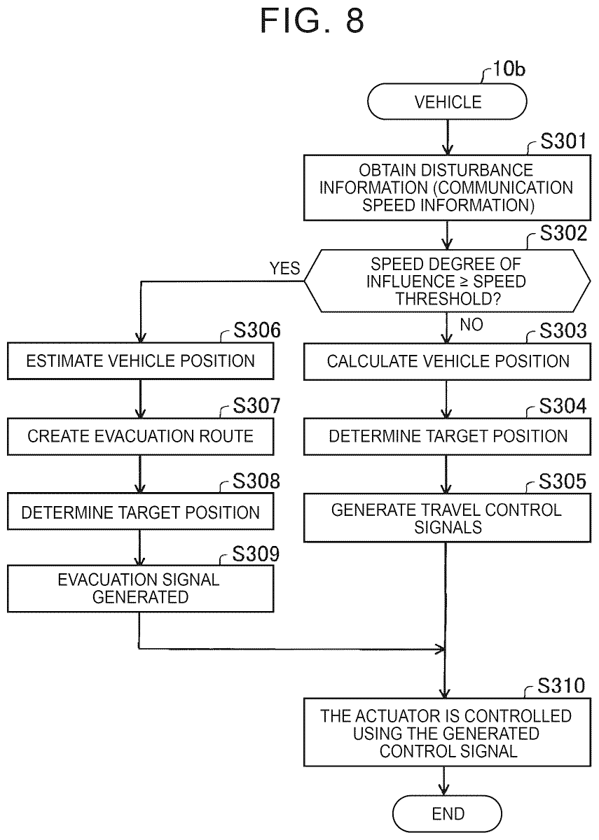

FIG. 8 is a flowchart illustrating a processing flow in the third embodiment. The process flow illustrated in FIG. 8 is repeatedly executed at predetermined time intervals, for example, in a period from the start point to at least one of the change point and the end point.

In S301, the acquisition unit 152 acquires communication rate information as disturbance information. In S302, the sensing unit 155 detects the presence of an external factor by comparing the speed degree of influence with the speed thresholds. When the speed degree of influence is less than the speed threshold, that is, when the sensing unit 155 does not detect that there is an external factor (S302:No), in S303, the calculation unit 151 calculates the position of the vehicle 10b using the captured images. In S304, the autonomous control unit 153b determines a target position to which the vehicle 10b is to be directed next using the vehicle position information and the reference route Ip. In S305, the autonomous control unit 153b generates a travel control signal for causing the vehicle 10b to travel toward the determined target position.

On the other hand, when the speed degree of influence is equal to or greater than the speed threshold, that is, when the sensing unit 155 detects that there is an external factor (S302:Yes), the autonomous control unit 153b executes S306. In S306, the autonomous control unit 153b estimates the position of the vehicle 10b using the management information In. In S307, the autonomous control unit 153b acquires the position of the evacuation location using the estimated position of the vehicle 10b and the map Mp. Then, the autonomous control unit 153b generates an evacuation route from the estimated position of the vehicle 10 to the position of the evacuation location. In S308, the autonomous control unit 153b determines a target position on the generated evacuation route. In S309, the autonomous control unit 153b generates an evacuation signal for moving the vehicle 10b toward the determined target position. In S310, the action control unit 154b controls the actuator in response to a control signal generated by the autonomous control unit 153b. Specifically, when the travel control signal is generated by the autonomous control unit 153b, the action control unit 154b controls the actuator using the travel control signal to cause the vehicle 10b to travel at the acceleration and the steering angle represented by the travel control signal. On the other hand, when the evacuation signal is generated by the autonomous control unit 153b, the action control unit 154b controls the actuator using the evacuation signal. Accordingly, the action control unit 154b moves the vehicle 10b to the evacuation location by causing the vehicle 10b to travel at the acceleration and the steering angle indicated by the evacuation signal.

According to the third embodiment, the vehicle control device 15b can acquire communication rate information, which is a kind of communication information, as the disturbance information. Then, the vehicle control device 15b can sense the presence of an external factor by comparing the speed degree of influence determined by the communication speed between the vehicle 10b and the external camera 90 with the speed thresholds to determine whether or not the communication between the vehicle 10b and the outside is disturbed. Then, the vehicle control device 15b can change the control form of the action of the vehicle 10b and move the vehicle 10b to the evacuation location by generating the evacuation signal and traveling using the evacuation signal when it is determined that there is a trouble in communication between the vehicle 10b and the outside, that is, when it is sensed that there is an external factor. In other words, the vehicle control device 15b can change the control form of the action of the vehicle 10b in accordance with the degree of influence by itself.

Further, according to the third embodiment, the vehicle control device 15b can change the control form of the action of the vehicle 10b according to the communication speed between the vehicle 10b and the external camera 90 by using the communication speed information.

Further, according to the third embodiment, in data mode control the vehicle control device 15 can estimate the position of the vehicle 10b and acquire the evacuation location as the destination using the estimated position of the vehicle 10b and the map Mp. Then, the vehicle control device 15b can generate an evacuation route from the estimated position of the vehicle 10b to the position of the evacuation location. Then, the vehicle control device 15b may determine a target position on the generated evacuation route and generate an evacuation signal for moving the vehicle 10b toward the determined target position. Accordingly, the vehicle control device 15b controls the actuator using the generated evacuation signal, and thus can continue the traveling by the unmanned driving without using the communication with the outside.

Further, according to the third embodiment, the control system 1b can drive the vehicle 10b by autonomous control without remotely controlling the vehicle 10b by the remote control devices 6, 6a.

### D. Other Embodiments

### D-1. Other Embodiment 1

The control systems 1, 1a, 1b may acquire both the communication information and the detected information as the disturbance information. Further, the control systems 1, 1a, 1b may acquire two or more pieces of information among the interference information, the weather information, and the assessment information as the communication information. With this configuration, the control systems 1, 1a, 1b can change the control form of the action of the vehicles 10, 10a, 10b by sensing an external factor or determining a magnitude of an effect of the external factor on the control of the unmanned driving using a plurality of pieces of information.

### D-2. Other Embodiment 2

The control systems 1, 1a, 1b may acquire information other than the communication information and the detected information as the disturbance information. When the vehicles 10, 10a, 10b are being manufactured in the factory, the control systems 1, 1a, 1b acquire manufacturing process information as disturbance information, for example. The manufacturing process information is information related to one manufacturing process being executed for the vehicles 10, 10a, 10b. The manufacturing process information includes, for example, information on a work state in one manufacturing process (hereinafter, action information). The work information is, for example, information indicating whether or not an inter-vehicle work in which a worker or the like enters an area between the front vehicles 10, 10a, 10b and the rear vehicles 10, 10a, 10b and works is performed. With such a configuration, the control systems 1, 1a, 1b can change the control form of the action of the vehicles 10, 10a, 10b by sensing an external factor or determining the magnitude of the effect of the external factor on the control of the unmanned driving using the communication information and the disturbance information other than the detected information.

### D-3. Other Embodiment 3

The control systems 1, 1a, 1b may change the control form from the external data mode to separate communication mode when it is sensed that there is an external factor using the disturbance information during the period in which the control of the external data mode is executed. In the separate communication mode, the vehicles 10, 10a, 10b travel in an unmanned driving by communicating with the outside using the second communication mode that differs from the first communication mode used in the external data mode. The second communication mode is, for example, at least one of a different line mode and a different band mode. In the other line mode, the vehicles 10, 10a, 10b acquire information using a communication line that differs from the communication line used in the external data mode and whose degree of influence by an external factor is equal to or less than a predetermined threshold. In the different band mode, the vehicles 10, 10a, 10b acquire information using a communication band that is different from the communication band used in the external data mode and whose degree of influence by the external factor is equal to or less than a predetermined threshold in the same communication line as the communication line used in the external data mode. With this configuration, the control systems 1, 1a, 1b can perform the following actions when it senses that there is an external factor affecting the communication between the vehicles 10, 10a, 10b and the outside and the communication between the plurality of external devices using disturbance information. The control systems 1, 1a, 1b can then use a communication mode that differs from the external data mode to allow the vehicles 10, 10a, 10b to communicate with the outside of the vehicles 10, 10a, 10b. In this way, the vehicles 10, 10a, 10b can receive and acquire various kinds of information such as the internal data Di, the management information In, the reference route Ip, and the map Mp from the outside. Accordingly, the vehicles 10, 10a, 10b can travel by the unmanned driving by the autonomous control when it is sensed that there is an external factor.

### D-4. Other Embodiment 4

The control systems 1, 1a, 1b may acquire information other than the degree of overlap as the detected information. Here, the detected information is, for example, information related to an imaging condition (hereinafter, imaging condition information) at the time of imaging the vehicles 10, 10a, 10b. The imaging condition information includes, for example, at least one of brightness information and shadow information. The brightness information is information related to brightness at the time of imaging the vehicles 10, 10a, 10b. The brightness information includes, for example, information indicating at least one of the brightness of the captured image, the brightness value of the captured image, the imaging time, the imaging date and time, the imaging time, the sunrise time, and sunset time of the date corresponding to at least one of the imaging date and time and the imaging time, and the illuminance of the illumination illuminating the track Ro. The shadow information is information related to a shadow reflected in the captured image. The shadow information includes information for determining whether or not a shadow generated from any one of the objects overlaps on the detected vehicles 10, 10a, 10b. Shadow information includes, for example, information indicating at least one of the appearance-shape of an object present in the detection range RG of the external camera 90, imaging time, imaging date and time, imaging time season, sunrise time, sunset time, and installation position and orientation of the illumination for illuminating the track Ro. Even in such a configuration, the control systems 1, 1a, 1b can change the control form of the action of the vehicles 10, 10a, 10b by sensing an external factor or determining the magnitude of the effect of the external factor on the control of the unmanned driving, using detection information.

### D-5. Other Embodiment 5

In the first embodiment, the communication information is information related to a communication state between the vehicle 10 and the remote control device 6. In addition, in the third embodiment, the communication information is information related to the communication status between the vehicle 10b and the external camera 90. In other words, in the above-described embodiments, the communication information is information related to the communication status between the vehicles 10, 10a, 10b and the outside. However, the present disclosure is not limited to the above. The communication information may be information related to a communication status between a plurality of different external devices. That is, the communication information may be, for example, information related to a communication status between the external camera 90 and the remote control devices 6, 6a. In this case, the evaluation information is information for determining the presence or absence of an external factor that affects communication between a plurality of external devices. The evaluation information may include, for example, communication speed information related to a communication speed between the plurality of external devices as an evaluation result when the communication status between the plurality of external devices is actually evaluated. The evaluation information may include disruption information indicating a disruption state of communication between a plurality of external devices, and may include power supply information. The evaluation information may include response information indicating that the second communication device communicably connected to the first communication device has detected that there is no response by the first communication device when the second communication device transmits a signal to the first communication device. The evaluation information may include reception information indicating that the second external device detects that information scheduled to be transmitted from the first external device to the second external device is not transmitted from the first external device. Here, the information scheduled to be transmitted from the first external device to the second external device is, for example, external sensor information. With this configuration, the control systems 1, 1a, 1b can change the control form of the action of the vehicles 10, 10a, 10b according to the communication status between the plurality of external devices used for the control of the unmanned driving.

### D-6. Other Embodiment 6

The control systems 1, 1a, 1b may calculate the position and the direction of the vehicles 10, 10a, 10b and generate a control signal such as a travel control signal, an evacuation signal, and a stopping signal using the information acquired by an internal sensor as a sensor mounted on the vehicles 10, 10a, 10b. Examples of the internal sensor include a camera, a Light Detection And Ranging (LiDAR), a millimeter-wave radar, an ultrasonic sensor, a GPS sensor, an acceleration sensor, and a gyro sensor. According to such a configuration, the vehicles 10, 10a, 10b can be driven by the unmanned driving by the autonomous control without acquiring various kinds of information such as the internal data Di and the management information In from the outside.

### D-7. Other Embodiment 7

The control systems 1, 1a, 1b may sense that there is an external factor in a case corresponding to at least one of the first case, the second case, the third case, and the fourth case during the period in which the control of the external data mode is executed, and may change the control form of the action of the vehicles 10, 10a, 10b.

In the first case, the external device cannot realize a predetermined function due to an external factor. In the first case, for example, the function of the remote control devices 6, 6a is stopped due to an external factor. Here, the sensing unit 155 is realized as a function of the vehicle control devices 15, 15a, 15b, for example. When the sensing unit 155 is realized as one function of the vehicle control devices 15, 15a, 15b, for example, the vehicle control devices 15, 15a, 15b transmit a request signal requesting a travel control signal to the remote control devices 6, 6a. Then, the vehicle control devices 15, 15a, 15b determine that the function of the remote control devices 6, 6a is stopped and corresponds to the first case when the travel control signal has not been received even after a predetermined stipulated period of time has elapsed. That is, the sensing unit 155 detects that the first case corresponds to a case in which a device communicably connected to the external device to be determined transmits a signal to the external device to be determined, using response information generated in a case where it is detected that there is no response by the external device to be determined.

The second case is a case where communication between a plurality of external devices is hindered by an external factor. In the second case, for example, the communication between the external camera 90 and the remote control devices 6, 6a is interrupted. Here, the sensing units 624, 624a are realized as a function of the remote control devices 6, 6a, for example. When the sensing units 624, 624a are realized as a function of the remote control devices 6, 6a, for example, the remote control devices 6, 6a determine as follows. In this case, the remote control devices 6, 6a determine that the communication between the external camera 90 and the remote control devices 6, 6a is interrupted and corresponds to the second case when the captured images have not been received from the external camera 90 even after a predetermined stipulated period of time has elapsed. In other words, the sensing units 624, 624a detect the second case using the received information generated when it is detected that the information scheduled to be transmitted from the first external device to the second external device is not transmitted.

The third case is a case where the external sensor cannot realize a predetermined function due to an external factor. In the third case, for example, the function of the external camera 90 is stopped due to an external factor. Here, the sensing units 624, 624a are realized as a function of the remote control devices 6, 6a, for example. When the sensing units 624, 624a are realized as a function of the remote control devices 6, 6a, for example, the remote control devices 6, 6a determine as follows. The remote control devices 6, 6a determines that the function of the external camera 90 is stopped and corresponds to the third case when receiving information the external camera 90 is not powered on. In other words, the sensing units 624, 624a detect that the third condition is satisfied using the power supply information indicating that the external sensor is not powered on. In addition, when the sensing units 624, 624a are realized as one function of the remote control devices 6, 6a, for example, the remote control devices 6, 6a may determine as follows. The remote control devices 6, 6a may transmit an activation instruction for activating the external camera 90 by turning on the power of the external camera 90 to the external camera 90. Then, the remote control devices 6, 6a may determine that the function of the external camera 90 is stopped and corresponds to the third case when the external camera 90 does not respond even after a predetermined stipulated period of time has elapsed. That is, the sensing units 624, 624a may detect that the second external device is in the third case using response information generated when the second external device communicably connected to the first external device detects that there is no response by the first external device when the second external device transmits a signal to the first external device.

The fourth case is a case where the communication between the vehicles 10, 10a, 10b and the external device is hindered by an external factor. The fourth case is, for example, a case where communication between the vehicles 10, 10a, 10b and the remote control devices 6, 6a is interrupted. Here, the sensing unit 155 is realized as a function of the vehicle control devices 15, 15a, 15b, for example. When the sensing unit 155 is realized as one function of the vehicle control devices 15, 15a, 15b, for example, the vehicle control devices 15, 15a, 15b determine that, when the travel control signal is not received from the remote control devices 6, 6a even after a predetermined stipulated period of time has elapsed, the communication between the vehicles 10, 10a, 10b and the remote control devices 6, 6a is interrupted and this corresponds to the fourth case. That is, the sensing unit 155 determines whether or not the fourth case is satisfied using the reception information generated when it is detected that the information scheduled to be transmitted from the external device toward the vehicles 10, 10a, 10b is not transmitted. When the sensing units 624, 624a are realized as one function of the remote control devices 6, 6a, for example, the remote control devices 6, 6a determine as follows. The remote control devices 6, 6a determine that the communication between the vehicles 10, 10a, 10b and the remote control devices 6, 6a is interrupted and corresponds to the fourth case when the internal sensor information cannot be received from the vehicles 10, 10a, 10b even after a predetermined stipulated period of time has elapsed. In other words, the sensing units 624, 624a may detect the fourth case using the reception information generated in a case where it is detected that the information scheduled to be transmitted from the vehicles 10, 10a, 10b to the external device is not transmitted.

With this configuration, the control systems 1, 1a, 1b can sense that there is an external factor in at least one of the first case, the second case, the third case, and the fourth case during the period in which the control of the external data mode is executed. Then, the control systems 1, 1a, 1b can change the control form of the action of the vehicles 10, 10a, 10b when it senses that there is an external factor by corresponding to at least one of the first case, the second case, the third case, and the fourth case. Note that the sensing units 155, 624, 624a may be realized as a function of an external sensor.

### D-8. Other Embodiment 8

The vehicle control devices 15, 15a, 15b may estimate the position of the vehicles 10, 10a, 10b using the peripheral detection sensor information outputted from the peripheral detection sensor in data mode control. The peripheral detection sensor is an internal sensor capable of acquiring information about a peripheral area of the vehicles 10, 10a, 10b. Examples of the peripheral detection sensor include a monocular camera, a stereo camera, a LiDAR, a millimeter-wave radar, and a sonar sensor. At this time, the vehicle control devices 15, 15a, 15b may estimate the absolute position of the vehicles 10, 10a, 10b using the peripheral detection sensor information, or may estimate the relative position with respect to the surrounding object existing in the surrounding area of the vehicles 10, 10a, 10b. The vehicle control devices 15, 15a, 15b may acquire the target acceleration and the target steering angle corresponding to the estimated position of the vehicles 10, 10a, 10b using the internal data Di to generate an evacuation signal including the acceleration and the steering angle as parameters. The vehicle control devices 15, 15a, 15b may acquire the target speed and the target steering angle corresponding to the estimated position of the vehicles 10, 10a, 10b using the internal data Di to generate an evacuation signal including the speed and the steering angle as parameters. The vehicle control devices 15, 15a, 15b may generate a bypass route for bypassing the vehicles 10, 10a, 10b and the surrounding object to avoid contacting the surrounding object. Then, the vehicle control devices 15, 15a, 15b may determine any position on the generated bypass route as the target position, and generate an evacuation signal for moving the vehicles 10, 10a, 10b toward the determined target position. With this configuration, the vehicle control devices 15, 15a, 15b can estimate the position of the vehicles 10, 10a, 10b using the peripheral detection sensor information in data mode control. Then, the vehicle control devices 15, 15a, 15b can generate the evacuation signal according to the position of the vehicles 10, 10a, 10b estimated using the peripheral detection sensor information. Accordingly, the vehicle control devices 15, 15a, 15b control the actuator using the generated evacuation signal, and thus can continue the traveling by the unmanned driving without using the communication with the outside.

### D-9. Other Embodiment 9

The vehicle control devices 15, 15a, 15b may estimate the position of the vehicles 10, 10a, 10b using the position detection sensor information outputted from the position detection sensor in data mode control. The position detecting sensor is an inner sensor capable of acquiring the position of the vehicles 10, 10a, 10b. The position detecting sensor is, for example, a GPS receiver capable of receiving radio waves transmitted from GPS satellites. The position detection sensor may be a GNSS receiver capable of receiving radio waves transmitted from GNSS satellites. At this time, the vehicle control devices 15, 15a, 15b may acquire the target acceleration and the target steering angle corresponding to the estimated position of the vehicles 10, 10a, 10b using the internal data Di to generate an evacuation signal including the acceleration and the steering angle as parameters. The vehicle control devices 15, 15a, 15b may acquire the target speed and the target steering angle corresponding to the estimated position of the vehicles 10, 10a, 10b using the internal data Di to generate an evacuation signal including the speed and the steering angle as parameters. The vehicle control devices 15, 15a, 15b may generate the evacuation route, the partial route, or the detour route according to the estimated position of the vehicles 10, 10a, 10b. Then, the vehicle control devices 15, 15a, 15b may determine any position on the generated route as the target position, and generate an evacuation signal for moving the vehicles 10, 10a, 10b toward the determined target position. With this configuration, the vehicle control devices 15, 15a, 15b can estimate the position of the vehicles 10, 10a, 10b using the position detection sensor information in data mode control. Then, the vehicle control devices 15, 15a, 15b can generate the evacuation signal according to the position of the vehicles 10, 10a, 10b estimated using the position detecting sensor information. Accordingly, the vehicle control devices 15, 15a, 15b control the actuator using the generated evacuation signal, and thus can continue the traveling by the unmanned driving without using the communication with the outside.

### D-10. Other Embodiment 10

The vehicle control devices 15, 15a, 15b may acquire the management information In from the outside using the second communication mode in separate communication control. For example, the vehicle control devices 15, 15a, 15b acquire, from the remote control devices 6, 6a, the management information In stored in the storage units 63, 63a of the remote control devices 6, 6a using the second communication mode. Then, the vehicle control devices 15, 15a, 15b may estimate the position of the vehicles 10, 10a, 10b using the management information In acquired from the outside. At this time, the vehicle control devices 15, 15a, 15b may acquire the target acceleration and the target steering angle corresponding to the estimated position of the vehicles 10, 10a, 10b to generate an evacuation signal including the acceleration and the steering angle as parameters. The vehicle control devices 15, 15a, 15b may acquire the target speed and the target steering angle corresponding to the estimated position of the vehicles 10, 10a, 10b to generate an evacuation signal including the speed and the steering angle as parameters. The vehicle control devices 15, 15a, 15b may generate the evacuation route, the partial route, or the detour route according to the estimated position of the vehicles 10, 10a, 10b. Then, the vehicle control devices 15, 15a, 15b may determine any position on the generated moving route as the target position, and generate an evacuation signal for moving the vehicles 10, 10a, 10b toward the determined target position. With this configuration, the vehicle control devices 15, 15a, 15b can acquire the management information In from the outside using the second communication mode while the control of the separate communication mode is being executed. Then, the vehicle control devices 15, 15a, 15b can estimate the position of the vehicles 10, 10a, 10b using the management information In acquired from the outside. Then, the vehicle control devices 15, 15a, 15b can generate the evacuation signal according to the position of the vehicles 10, 10a, 10b estimated using the management information In acquired from the outside. Accordingly, when it is determined that there is an external factor, the vehicle control devices 15, 15a, 15b control the actuator using the generated evacuation signal, so that the vehicle can continue traveling by the unmanned driving using the communication mode that is not the external data mode.

### D-11. Other Embodiment 11

During the control of the separate communication mode, the vehicle control devices 15, 15a, 15b may acquire the external sensor information from the outside using the second communication mode. Then, the vehicle control devices 15, 15a, 15b may estimate the position of the vehicles 10, 10a, 10b using the external sensor information obtained from the outside. At this time, the vehicle control devices 15, 15a, 15b may acquire the target acceleration and the target steering angle corresponding to the estimated position of the vehicles 10, 10a, 10b to generate an evacuation signal including the acceleration and the steering angle as parameters. The vehicle control devices 15, 15a, 15b may acquire the target speed and the target steering angle corresponding to the estimated position of the vehicles 10, 10a, 10b to generate an evacuation signal including the speed and the steering angle as parameters. The vehicle control devices 15, 15a, 15b may generate the evacuation route, the partial route, or the detour route according to the estimated position of the vehicles 10, 10a, 10b. Then, the vehicle control devices 15, 15a, 15b may determine any position on the generated moving route as the target position, and generate an evacuation signal for moving the vehicles 10, 10a, 10b toward the determined target position. With this configuration, the vehicle control devices 15, 15a, 15b can acquire the external sensor information from the outside using the second communication mode while the control of the separate communication mode is being executed. Then, the vehicle control devices 15, 15a, 15b can estimate the position of the vehicles 10, 10a, 10b using the external sensor information obtained from the outside. Then, the vehicle control devices 15, 15a, 15b can generate the evacuation signal according to the position of the vehicles 10, 10a, 10b estimated using the external sensor information acquired from the outside. Thus, the vehicle control devices 15, 15a, 15b control the actuator using the generated evacuation signal, so that the vehicle can continue traveling by the unmanned driving using a communication mode that is not the external data mode.

### D-12. Other Embodiment 12

In the first embodiment, the internal data Di is data in which the position of the vehicles 10, 10a, 10b and the target control value are associated with each other. On the other hand, the internal data Di may be data in which temporal information is associated with a target control value. The time information is information related to at least one time of an elapsed time from a predetermined time, a current time, and an unreceived time that is a time at which the information was scheduled to be received and is a time at which the information was not received. In other words, the internal data Di may be data indicating target control values at respective time points. The target control value is a target value of each parameter included in the evacuation signal. When the internal data Di is data in which the time information and the target control value are associated with each other, the internal data Di is, for example, data in which the present time and the target control value are associated with each other. The internal data Di may be data in which the elapsed time from any point in time, such as the starting point of travel by the unmanned driving, is associated with the target control value. With this configuration, when it is determined that there is an external factor, the vehicle control devices 15, 15a, 15b can generate the evacuation signal without estimating the position of the vehicles 10, 10a, 10b by acquiring the temporal information. Accordingly, the vehicle control devices 15, 15a, 15b control the actuator using the generated evacuation signal, and thus can continue the traveling by the unmanned driving without using the communication with the outside.

### D-13. Other Embodiment 13

The internal data Di may be data for generating a moving route according to the time-information. With such a configuration, when it is determined that there is an external factor, the vehicle control devices 15, 15a, 15b can generate a moving route corresponding to the time information without estimating the position of the vehicles 10, 10a, 10b by acquiring the time information.

### D-14. Other Embodiment 14

The internal data Di may be data indicating a target control value for causing the vehicles 10, 10a, 10b to execute a predetermined traveling action. In other words, the internal data Di may be data indicating a predetermined target control value regardless of the position and the duration of the vehicles 10, 10a, 10b. For example, when the vehicles 10, 10a, 10b are stopped, the internal data Di may include a value less than 0 as the target acceleration and a value less than the present speed as the target speed in order to decelerate the vehicles 10, 10a, 10b. When stopping the vehicles 10, 10a, 10b, the internal data Di may further include a target steering angle. Further, for example, when the vehicles 10, 10a, 10b are caused to travel toward the evacuation site provided at one end side in the widthwise direction of the track Ro, the internal data Di may include a target steering angle for steering the vehicles 10, 10a, 10b to one end side. When the vehicles 10, 10a, 10b are moved toward the evacuation site provided at one end of the track Ro, the internal data Di may further include at least one of the target acceleration and the target velocity. The vehicle control devices 15, 15a, 15b acquire the target control value using the internal data Di and generates evacuation signal. With this configuration, when it is sensed that there is an external factor, the vehicle control devices 15, 15a, 15b can generate the evacuation signal by acquiring the target control value without estimating the position of the vehicles 10, 10a, 10b or acquiring the temporal information. Accordingly, the vehicle control devices 15, 15a, 15b control the actuator using the generated evacuation signal, and thus can continue the traveling by the unmanned driving without using the communication with the outside.

The internal data Di may be data including a single target for each parameter. For example, the vehicle control devices 15, 15a, 15b acquire the target control value using the internal-data Di. Then, the vehicle control devices 15, 15a, 15b repeatedly generate an evacuation signal indicating the acquired target control value at a predetermined cycle. With this configuration, when it is determined that there is an external factor, the vehicle control devices 15, 15a, 15b can repeatedly generate the same evacuation signal at a predetermined cycle without estimating the position of the vehicles 10, 10a, 10b or acquiring the temporal information. Thus, the vehicle control devices 15, 15a, 15b can cause the vehicles 10, 10a, 10b to repeatedly perform the same action in a predetermined cycle.

The internal data Di may be data indicating target control values at a plurality of different-timings. In this case, for example, the vehicle control devices 15, 15a, 15b acquire the target control values in chronological order using the internal-data Di. Then, the vehicle control devices 15, 15a, 15b generate an evacuation signal indicating the acquired target control value. With this configuration, when it is determined that there is an external factor, the vehicle control devices 15, 15a, 15b can generate the evacuation signals at a plurality of different timings without estimating the position of the vehicles 10, 10a, 10b or acquiring the time information.

### D-15. Other Embodiment 15

The internal data Di may be data for generating a travel route of the vehicles 10, 10a, 10b, such as an evacuation route, a partial route, and a detour route, in order to cause the vehicles 10, 10a, 10b to perform a predetermined travel action. For example, when the vehicles 10, 10a, 10b are caused to travel toward the evacuation site provided at one end side in the widthwise direction of the track Ro, the internal data Di includes data for generating a moving route for steering the vehicles 10, 10a, 10b to one end side. The vehicle control devices 15, 15a, 15b may generate a moving route using the internal data Di, determine a target position at any position on the generated moving route, and generate an evacuation signal for moving the vehicles 10, 10a, 10b toward the determined target position. With such a configuration, when it is determined that there is an external factor, the vehicle control devices 15, 15a, 15b can generate a traveling route without estimating the position of the vehicles 10, 10a, 10b or acquiring the temporal information, and generate an evacuation signal. Accordingly, the vehicle control devices 15, 15a, 15b control the actuator using the generated evacuation signal, and thus can continue the traveling by the unmanned driving without using the communication with the outside.

### D-16. Other Embodiment 16

In the embodiments from the first embodiment to the third embodiment, when it is sensed that there is an external factor, the vehicle control devices 15, 15a, 15b generate an emergency evacuation signal for urgently evacuating the vehicles 10, 10a, 10b. The emergency evacuation signal is, for example, an evacuation signal and a stop signal. On the other hand, when it is sensed that there is an external factor, the vehicle control devices 15, 15a, 15b may generate an evacuation signal and another control signal that differs from the stopping signal, and control the actuator using the generated control signal to drive the vehicles 10, 10a, 10b. When it is sensed that there is an external factor, for example, the vehicle control devices 15, 15a, 15b may generate a non-emergency evacuation signal for causing the vehicles 10, 10a, 10b to perform a predetermined traveling action without causing the vehicles 10, 10a, 10b to be evacuated to the evacuation location.

For example, when the vehicle 10 is being produced by transporting the vehicle 10 using the vehicle 10 traveling by the unmanned driving in the factory as in the present embodiment, the non-emergency evacuation signal is a control signal for causing the vehicles 10, 10a, 10b to execute the following action. Here, the non-emergency evacuation signal is, for example, a signal for decelerating the vehicles 10, 10a, 10b to move the vehicles 10, 10a, 10b to a particular location on the manufacturing-line that differs from the evacuation location. A particular location on the production line is then, for example, a production location that performs the next production process that is scheduled to be performed on the vehicles 10, 10a, 10b. The particular location on the manufacturing line may be a manufacturing location that is nearest to the current location of the vehicles 10, 10a, 10b, or may be a manufacturing location that performs an inspection process for inspecting the vehicles 10, 10a, 10b. A particular location on the manufacturing line may be a maintenance location for replacing or repairing a device mounted on a vehicles 10, 10a, 10b.

With such a configuration, the vehicle control devices 15, 15a, 15b can generate at least one of the emergency evacuation signal and the non-emergency evacuation signal according to the traveling state of the vehicles 10, 10a, 10b. Accordingly, when it is determined that there is an external factor, the vehicle control devices 15, 15a, 15b can continue the traveling by the unmanned driving in one of the control forms of the internal data mode and the separate communication mode.

### D-17. Other Embodiment 17

In a case where the vehicles 10, 10a, 10b are traveling in the factory by unmanned driving, when it is sensed that there is an external factor, the vehicle control devices 15, 15a, 15b may be configured as follows. The vehicle control devices 15, 15a, 15b may generate one of the emergency evacuation signal and the non-emergency evacuation signal according to the moving state of the vehicles 10, 10a, 10b. The vehicle control devices 15, 15a, 15b may change a control form of the action of the vehicles 10, 10a, 10b in accordance with a manufacturing process performed on the vehicles 10, 10a, 10b.

For example, when the previous manufacturing process is executed on the vehicles 10, 10a, 10b in chronological order rather than the inspection process for inspecting the vehicles 10, 10a, 10b among the plurality of manufacturing processes executed in chronological order, the vehicle control devices 15, 15a, 15b may execute the following process. In this case, the vehicle control devices 15, 15a, 15b may generate an emergency evacuation signal and control the actuator using the emergency evacuation signal. On the other hand, when a later manufacturing process is executed for the vehicles 10, 10a, 10b in chronological order than the inspection process, the vehicle control devices 15, 15a, 15b may generate a non-emergency evacuation signal and control the actuator using the non-emergency evacuation signal. The previous step in chronological order than the test step is, for example, an assembly step of assembling a vehicles 10, 10a, 10b. The later manufacturing process in chronological order than the inspection process is, for example, a storage process in which the vehicles 10, 10a, 10b are stored in a storage location such as a yard. With such a configuration, when it is sensed that there is an external factor, the vehicles 10, 10a, 10b in which the inspection process has been completed can be moved to an arbitrary location such as a maintenance location without being urgently evacuated to the evacuation location. Even when the manufacturing process prior to the inspection process is executed for the vehicles 10, 10a, 10b, the vehicle control devices 15, 15a, 15b may generate the non-evacuation control signal and control the actuator using the non-evacuation control signal. Further, even when the manufacturing process after the inspection process is executed for the vehicles 10, 10a, 10b, the vehicle control devices 15, 15a, 15b may generate an emergency evacuation signal and control the actuator using the emergency evacuation signal.

Further, for example, when a manufacturing process in which the number of workers engaged in the manufacturing process is smaller than a predetermined stipulated number of workers is executed on the vehicles 10, 10a, 10b, the vehicle control devices 15, 15a, 15b may execute the following process. The vehicle control devices 15, 15a, 15b may generate a non-emergency evacuation signal to control the actuator using the non-emergency evacuation signal. A manufacturing process in which the number of workers engaged in the manufacturing process is smaller than a stipulated number is, for example, a storage process. With such a configuration, when it is sensed that there is an external factor, the manufacturing process in which the number of workers engaged in the manufacturing process is smaller than the stipulated number is executed for the vehicles 10, 10a, 10b, the following can be performed. In this case, the vehicle control devices 15, 15a, 15b can move the vehicles 10, 10a, 10b to any place, such as a maintenance place, without urgently evacuating to the evacuation place. Even when a manufacturing process in which the number of workers engaged in the manufacturing process is smaller than the stipulated number is executed for the vehicles 10, 10a, 10b, the vehicle control devices 15, 15a, 15b may generate an emergency evacuation signal and control the actuator using the emergency evacuation signal. In addition, even when a manufacturing process in which the number of workers engaged in the manufacturing process is equal to or larger than a stipulated number is executed for the vehicles 10, 10a, 10b, the vehicle control devices 15, 15a, 15b may generate a non-emergency evacuation signal and control the actuator using the non-emergency evacuation signal.

Further, for example, when a manufacturing process capable of securing a non-object area is being executed on the vehicles 10, 10a, 10b, the vehicle control devices 15, 15a, 15b may execute the following process. The non-object area is an area in which other objects do not exist over a stipulated area around the vehicles 10, 10a, 10b. The vehicle control devices 15, 15a, 15b may generate a non-emergency evacuation signal to control the actuator using the non-emergency evacuation signal. A manufacturing process capable of securing a non-object area in the periphery of the vehicles 10, 10a, 10b over a stipulated area is, for example, a storage process. With such a configuration, in a case where it is sensed that there is an external factor, and in a case where a manufacturing process capable of securing a non-object area over a stipulated area around the vehicles 10, 10a, 10b is performed on the vehicles 10, 10a, 10b, the following can be performed. In this case, the vehicle control devices 15, 15a, 15b can move the vehicles 10, 10a, 10b to any place, such as a maintenance place, without urgently evacuating to the evacuation place. Even when a manufacturing process capable of securing a non-object area over a stipulated area around the vehicles 10, 10a, 10b is performed on the vehicles 10, 10a, 10b, the vehicle control devices 15, 15a, 15b may generate an emergency evacuation signal and control the actuator using the emergency evacuation signal. In addition, even when a manufacturing process in which a non-object area cannot be secured over a stipulated area around the vehicles 10, 10a, 10b is being performed on the vehicles 10, 10a, 10b, the vehicle control devices 15, 15a, 15b may generate a non-emergency evacuation signal and control the actuator using the non-emergency evacuation signal.

The classification and contents of the manufacturing process performed in the factory are not limited to the above. For example, the assembling step may include a plurality of manufacturing steps such as an assembling step of assembling the interior component and the exterior component to the vehicle body and a connection step of electrically connecting the assembled component. In addition, a manufacturing process other than the assembly process, the inspection process, and the storage process may be executed in the factory. In the factory, for example, a manufacturing process such as a press process of manufacturing a vehicle body or a component by press working, a welding process of welding a vehicle body or a component, and a coating process of coating a vehicle body may be performed.

### D-18. Other Embodiment 18

When it is determined that there is an external factor, the vehicle control devices 15, 15a, 15b may change the control form of the action of the vehicles 10, 10a, 10b according to whether or not the predetermined information can be acquired. For example, when it is determined that there is an external factor, when at least one of the peripheral detection sensor information and the position detection sensor information can be acquired, the vehicle control devices 15, 15a, 15b may execute the following process. The vehicle control devices 15, 15a, 15b may generate a non-emergency evacuation signal to control the actuator using the non-emergency evacuation signal. With this configuration, when at least one of the peripheral detection sensor information and the position detection sensor information can be acquired, the vehicle control devices 15, 15a, 15b can move the vehicles 10, 10a, 10b to an arbitrary location such as a maintenance location without urgently evacuating to the evacuation location.

### D-19. Other Embodiment 19

The control systems 1, 1a, 1b may change the control form of the action of the vehicles 10, 10a, 10b from the external data mode to the pattern self-propelled mode by setting the pattern self-propelled flag for executing the control by the pattern self-propelled mode to ON when sensing that there is an external factor. The pattern free-running mode is one of an internal data mode and a separate communication mode communication mode. With this configuration, the control systems 1, 1a, 1b can change the control form of the action of the vehicles 10, 10a, 10b from the external data mode to the pattern self-propelled mode by setting the pattern self-propelled flag to ON when it is determined that there is an external factor.

### D-20. Other Embodiment 20

The control systems 1, 1a, 1b may set the pattern self-propelled flag to OFF immediately when the transmission and reception of information scheduled to be transmitted and received is resumed after sensing that there is an external factor using the communication information and setting the pattern self-propelled flag to ON. With this configuration, the control systems 1, 1a, 1b can determine that the effect of the external factor can be reduced when the communication state between the vehicles 10, 10a, 10b and the outside and the communication state between the plurality of external devices are improved. The control systems 1, 1a, 1b can change the control form of the action of the vehicles 10, 10a, 10b from the pattern self-propelled mode to the external data mode by setting the pattern self-propelled flag to OFF. Thus, the control systems 1, 1a, 1b can resume the control in the external data mode.

### D-21. Other Embodiment 21

The control systems 1, 1a, 1b may change the control form of the vehicles 10, 10a, 10b from the pattern self-propelled mode to the external data mode by setting the pattern self-propelled flag to OFF when the predetermined flag release condition is satisfied after setting the pattern self-propelled flag to ON. The flag release condition is a condition for reducing the influence of an external factor and resuming the control by the external data mode. The flag release condition includes, for example, at least one of a first release condition, a second release condition, and a third release condition. The first release condition is a condition indicating that the communication line used during the period in which the control of the external data mode is executed is usable. The second release condition is a condition indicating that information scheduled to be transmitted and received is being transmitted and received. The third release condition is a condition indicating that there is no abnormality in the received information.

For example, when the communication between the vehicles 10, 10a, 10b and the remote control devices 6, 6a is interrupted, the control systems 1, 1a, 1b determine that the first cancellation condition is satisfied when the communication line used for the communication between the vehicles 10, 10a, 10b and the remote control devices 6, 6a is restored. The case where the communication line used for the communication between the vehicles 10, 10a, 10b and the remote control devices 6, 6a is restored is, for example, a case where the vehicle control devices 15, 15a, 15b resume the reception of the travel control signal from the remote control devices 6, 6a.

For example, if the function of the remote control devices 6, 6a is deactivated, the control systems 1, 1a, 1b determine that the second release criterion is satisfied if the remote control devices 6, 6a receive information that is scheduled to be received by the remote control devices 6, 6a. The case where the information scheduled to be received by the remote control devices 6, 6a is received by the remote control devices 6, 6a is, for example, a case where the remote control devices 6, 6a receive captured images from the external cameras 90.

For example, when communication between the vehicles 10, 10a, 10b and the remote control devices 6, 6a is interrupted, the control systems 1, 1a, 1b determine that the third cancellation condition is satisfied when the travel control signal received by the vehicle control devices 15, 15a, 15b include a normal value without including an abnormal value. For example, when the driving control signal is generated by the remote control devices 6, 6a at a predetermined cycle and transmitted from the remote control devices 6, 6a to the vehicles 10, 10a, 10b, the control systems 1, 1a, 1b determine whether the received information is abnormal, for example, as follows.

When the communication between the vehicles 10, 10a, 10b and the remote control devices 6, 6a is disturbed, the traveling control signal is not correctly generated and transmitted and received, and the values of the parameters of the plurality of traveling control signals at different timings may be fixed to a specific value. Therefore, for example, when the values of the parameters of the plurality of travel control signals transmitted from the remote control devices 6, 6a and received by the vehicle control devices 15, 15a, 15b are fixed to a specific value, the control systems 1, 1a, 1b determine that the received information is abnormal. The case where the travel control signal is fixed to a specific value is, for example, a case where the values of the parameters of the travel control signal change without changing from the values of the parameters of the travel control signal at the first timing at a plurality of consecutive timings subsequent to the first timing.

When the communication between the vehicles 10, 10a, 10b and the remote control devices 6, 6a is disturbed, the traveling control signal may not be correctly generated and transmitted or received, and the values of the parameters of the traveling control signal may be out of a predetermined range. Therefore, for example, when the parameter values of the travel control signals transmitted from the remote control devices 6, 6a and received by the vehicle control devices 15, 15a, 15b are estimated to be abnormal values, the control systems 1, 1a, 1b determine that there is an abnormality in the received information. The case in which the value is estimated to be an abnormal value is, for example, a case in which the value of each parameter of the travel control signal is out of a predetermined threshold range. The case of being estimated to be an outlier may be a case of being an outlier when the values of the parameters of the travel control signals at a plurality of different timings are classified by a statistical method.

With this configuration, the control systems 1, 1a, 1b can set the pattern self-propelled flag to OFF when the predetermined flag release condition is satisfied after the pattern self-propelled flag is set to ON. Thus, the control systems 1, 1a, 1b can change the control form of the vehicles 10, 10a, 10b from the pattern self-propelled mode to the external data mode. In this way, the control systems 1, 1a, 1b can determine whether or not the effect of the external factor can be reduced. Then, the control systems 1, 1a, 1b can change the control form of the vehicles 10, 10a, 10b from the pattern self-propelled mode to the external data mode by setting the pattern self-propelled flag to OFF when it is determined that the effect of the external factor can be reduced. Thus, the control systems 1, 1a, 1b can resume the control in the external data mode.

### D-22. Other Embodiment 22

The calculation units 151, 621, 621a may calculate the position and the direction of the vehicles 10, 10a, 10b using information acquired by an external sensor of a type different from that of the external camera 90. The calculation units 151, 621, 621a may calculate the position and the direction of the vehicles 10, 10a, 10b using, for example, the measured point cloud data acquired by a lidar (hereinafter referred to as an external lidar) as an external sensor. Here, the calculation units 151, 621, 621a calculates the position and the direction of the vehicles 10, 10a, 10b by, for example, template matching using the measured point cloud data and the reference point cloud data prepared in advance. The reference point cloud data is reference data used as a template in matching with the measurement point cloud data. The reference point cloud data is, for example, virtual three-dimensional point cloud data generated based on three-dimensional CAD data representing the appearance-shape of the vehicles 10, 10a, 10b. For example, one of Iterative Closest Point (ICP) and Normal Distributions Transform (NDT) is used as the algorithm for matching by the calculation units 151, 621, 621a.

### D-23. Other Embodiment 23

In the above-described first embodiment and the above-described second embodiment, the process from the acquisition of the vehicle position information to the generation of the travel control signal is executed by the remote control devices 6, 6a as the control devices 5, 5a while the control of the external data mode is being executed. On the other hand, the vehicles 10, 10a may execute at least a part of the process from acquiring the vehicle position information to generating the travel control signal. For example, the following forms (1) to (3) may be used.

(1) The remote control devices 6, 6a may acquire the vehicle position information, determine a target position to which the vehicle 10 should be directed next, and generate a route from the current position of the vehicles 10, 10a represented by the acquired vehicle position information to the target position. The remote control devices 6, 6a may generate a route to a target position between the current location and the destination, or may generate a route to the destination. The remote control devices 6, 6a may transmit the generated route to the vehicles 10, 10a. The vehicles 10, 10a may generate a travel control signal so that the vehicles 10, 10a travel on a route received from the remote control devices 6, 6a, and control the actuator using the generated travel control signal.

(2) The remote control devices 6, 6a may acquire the vehicle position information and transmit the acquired vehicle position information to the vehicles 10, 10a. The vehicles 10, 10a may determine a target position to which the vehicles 10, 10a should be directed next, generate a route from the current position of the vehicles 10, 10a represented in the received vehicle position information to the target position, generate a travel control signal so that the vehicles 10, 10a travels on the generated route, and control an actuator of the vehicles 10, 10a using the generated travel control signal.

(3) In the above embodiments (1) and (2), an internal sensor may be mounted on the vehicles 10, 10a, and a detection result outputted from the internal sensor may be used for at least one of generation of a route and generation of a travel control signal. The inner sensor is a sensor mounted on the vehicles 10, 10a. The internal sensor may include, for example, an in-vehicle camera, an in-vehicle lidar, a millimeter wave radar, a sonar sensor, an ultrasonic sensor, a GPS sensor, an accelerometer sensor, a gyroscope sensor, and the like. For example, in the above aspect (1), the remote control devices 6, 6a may acquire the detection result of the internal sensor and reflect the detection result of the internal sensor in the route when generating the route. In the aspect (1), the vehicles 10, 10a may acquire the detection result of the internal sensor and reflect the detection result of the internal sensor in the travel control signal when generating the travel control signal. In the aspect (2), the vehicles 10, 10a may acquire the detection result of the internal sensor and reflect the detection result of the internal sensor in the route when generating the route. In the aspect (2), the vehicles 10, 10a may acquire the detection result of the internal sensor and reflect the detection result of the internal sensor in the travel control signal when generating the travel control signal.

### D-24. Other Embodiment 24

In the third embodiment, an internal sensor may be mounted on the vehicle 10b, and the detection result outputted from the internal sensor may be used for at least one of the generation of the route, the generation of the travel control signal, and the generation of the evacuation signal. For example, the vehicle 10b may acquire the detection result of the internal sensor and reflect the detection result of the internal sensor in the route when generating the route. The vehicle 10b may acquire the detection result of the internal sensor and reflect the detection result of the internal sensor in the travel control signal and the evacuation signal when generating the travel control signal and the evacuation signal. The vehicle 10b may acquire a detection result of the internal sensor and reflect the detection result of the internal sensor in the stop signal when generating the stop signal.

### D-25. Other Embodiment 25

In the third embodiment, the vehicle 10b acquires the vehicle position information using the detection result of the external sensor. On the other hand, an internal sensor is mounted on the vehicle 10b, and the vehicle 10b may acquire the vehicle position information using the detection result of the internal sensor, determine the target position to which the vehicle 10b should be directed next, generate a route from the current position of the vehicle 10b represented in the acquired vehicle position information to the target position, generate a travel control signal for traveling the generated route, and control the actuator using the generated travel control signal. Further, the vehicle 10b may acquire the vehicle position information using the detection result of the internal sensor, determine the evacuation location as the target position, generate a route from the current position of the vehicle 10b represented in the acquired vehicle position information to the evacuation location, generate an evacuation signal for traveling the generated route, and control the actuator using the generated evacuation signal. The vehicle 10b can then travel without using any of the detect results of the external sensors. The vehicle 10b may acquire the target arrival time and the traffic jam information from the outside of the vehicle 10b and reflect the target arrival time and the traffic jam information on at least one of the route and the travel control signal. In addition, all the functional configurations of the control systems 1, 1a, 1b may be provided in the vehicles 10, 10a, 10b. That is, the vehicles 10, 10a, 10b alone may implement a process implemented by the control systems 1, 1a, 1b, such as acquiring the disturbance information and controlling the action of the vehicles 10, 10a, 10b using the disturbance information.

### D-26. Other Embodiment 26

In the first embodiment, the remote control devices 6, 6a automatically generates a travel control signal to be transmitted to the vehicles 10, 10a. On the other hand, the remote control devices 6, 6a may generate a travel control signal to be transmitted to the vehicles 10, 10a in accordance with an action of an external operator located outside the vehicles 10, 10a. For example, an external operator may operate a control device including a display for displaying captured images outputted from an external sensor, a steering for remotely controlling a vehicles 10, 10a, an accelerator pedal, a brake pedal, and a communication device for communicating with the remote control devices 6, 6a through wired communication or wireless communication, and the remote control devices 6, 6a may generate a travel control signal corresponding to an action applied to the control device.

### D-27. Other Embodiment 27

In the above-described embodiments, the vehicles 10, 10a, 10b may have a configuration that can be moved by unmanned driving, and may be, for example, in the form of a platform that includes the configuration described below. Specifically, the vehicles 10, 10a, 10b may include at least a vehicle control devices 15, 15a, 15b and an actuator of the vehicle 10 in order to perform three functions of “running,” “turning,” and “stopping” by unmanned driving. When the vehicles 10, 10a, 10b acquire information from the outside for unmanned driving, the vehicles 10, 10a, 10b may further include the communication device 14. That is, in the vehicles 10, 10a, 10b that can be moved by unmanned driving, at least a part of an interior component such as a driver's seat or a dashboard may not be mounted, at least a part of an exterior component such as a bumper or a fender may not be mounted, and a body shell may not be mounted. In this case, the remaining components such as the body shell may be mounted on the vehicles 10, 10a, 10b until the vehicles 10, 10a, 10b are shipped from the factory, or the remaining components such as the body shell may be mounted on the vehicles 10, 10a, 10b after the vehicles 10, 10a, 10b are shipped from the factory while the remaining components such as the body shell are not mounted on the vehicles 10, 10a, 10b. Each component may be attached from any direction, such as the upper, lower, front, back, right, or left side of the vehicles 10, 10a, 10b, may be attached from the same direction, each may be attached from different directions. It should be noted that position determination and the like can be performed in the same manner as in the vehicles 10, 10a, 10b in the above-described embodiments.

### D-28. Other Embodiment 28

The vehicles 10, 10a, 10b may be manufactured by combining a plurality of modules. The modular means a unit composed of a plurality of components arranged according to a part or a function of the vehicles 10, 10a, 10b. For example, the platform of the vehicles 10, 10a, 10b may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, components constituting parts of the vehicles 10, 10a, 10b that differ from the platform may be modularized. Further, the various modules may include any exterior parts such as bumpers and grills, and any interior parts such as sheets and consoles. In addition, the present disclosure is not limited to the vehicles 10, 10a, 10b, and a mobile body of any form may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasts or megacasts. For example, the front module, the central module, and the rear module described above may be manufactured using gigacast.

### D-29. Other Embodiment 29

Transporting the vehicles 10, 10a, 10b using the traveling of the vehicles 10, 10a, 10b by the unmanned driving is also referred to as “self-propelled conveyance”. A configuration for realizing self-propelled conveyance is also referred to as a “vehicle remote control autonomous traveling conveyance system”. Further, a production method of producing the vehicles 10, 10a, 10b using self-propelled conveyance is also referred to as “self-propelled production”. In self-propelled manufacturing, for example, at least a part of the conveyance of the vehicles 10, 10a, 10b is realized by self-propelled conveyance in a plant for manufacturing the vehicles 10, 10a, 10b.

The present disclosure is not limited to each of the above embodiments, and can be realized by various configurations without departing from the spirit thereof. For example, the technical features of the embodiments corresponding to the technical features in the respective embodiments described in SUMMARY can be appropriately replaced or combined in order to solve some or all of the above-described problems or to achieve some or all of the above-described effects. Further, when the technical features are not described as essential in the present specification, these can be deleted as appropriate.

What is claimed is:

1. A control device for controlling an action of a mobile body that is movable by unmanned driving, the control device comprising:
an acquisition unit for acquiring disturbance information regarding an external factor that influences control of the unmanned driving and that is from an outside that is different from the mobile body; and
a control unit for changing a control form of the action of the mobile body using the disturbance information.

2. The control device according to claim 1, wherein, when presence of the external factor is sensed using the disturbance information, in a period in which the mobile body is executing control of an external data mode in which the mobile body moves by the unmanned driving using communication with the outside of the mobile body,
the control unit changes the control form to one of an internal data mode in which the mobile body moves by the unmanned driving without using communication with the outside, and a separate communication mode in which the mobile body moves by the unmanned driving, by the mobile body communicating with the outside using a second communication mode that is different from a first communication mode used in the external data mode.

3. The control device according to claim 1, wherein the disturbance information includes at least one of communication information, relating to at least one of a communication state between the mobile body and the outside and a communication state among a plurality of external devices that is used for controlling the action of the mobile body and that is installed at a location that is different from that of the mobile body, and detection information, relating to a detection state when the mobile body is detected by a sensor.

4. The control device according to claim 1, wherein, when a degree of influence indicating a magnitude of influence of the external factor on the control of the unmanned driving is compared with a threshold value that is set in advance, and the degree of influence is no smaller than the threshold value, the control unit causes the mobile body to execute the action that is different from when the degree of influence is smaller than the threshold value.

5. A control method for controlling an action of a mobile body that is movable by unmanned driving, the control method comprising:
an acquiring process of acquiring disturbance information regarding an external factor that influences control of the unmanned driving of the mobile body and that is from an outside that is different from the mobile body; and
a control process of changing a control form of the action of the mobile body using the disturbance information.
